(19) United States
(12) Patent Application Publication
(10) Pub. No.: US 2016/0337662 A1
(43) Pub. Date: Nov. 17, 2016

(54) STORAGE AND SIGNALING RESOLUTIONS OF MOTION VECTORS

(71) Applicant: QUALCOMM Incorporated, San Diego, CA (US)

(72) Inventors: Chao Pang, Marina del Ray, CA (US); Krishnakanth Rapaka, San Diego, CA (US); Vadim Seregin, San Diego, CA (US); Marta Karczewicz, San Diego, CA (US); Rajan Laxman Joshi, San Diego, CA (US)

(21) Appl. No.: 15/151,429

(22) Filed: May 10, 2016

Related U.S. Application Data
(60) Provisional application No. 62/159,839, filed on May 11, 2015.
(60) Provisional application No. 62/173,248, filed on Jun. 9, 2015.
(60) Provisional application No. 62/175,179, filed on Jun. 12, 2015.

(51) Int. Cl. H04N 19/52; H04N 19/182; H04N 19/176

(52) U.S. Cl. CPC H04N 19/52; H04N 19/176; H04N 19/182

(57) ABSTRACT

An example method of decoding video data includes obtaining, from a video bitstream, a representation of a difference between a motion vector (MV) predictor and a MV that identifies a predictor block for a current block of video data in a current picture; obtaining, from the video bitstream, a syntax element indicating whether adaptive motion vector resolution (AMVR) is used for the current block; determining, based on the representation of the difference between the MV predictor and the MV that identifies the predictor block, a value of the MV; storing the value of the MV at fractional-pixel resolution regardless of whether AMVR is used for the current block and regardless of whether the predictor block is included in the current picture; determining, based on the value of the stored MV, pixel values of the predictor block; and reconstructing the current block based on the pixel values of the predictor block.

### RELATED APPLICATIONS

This application is related to U.S. Provisional Application No. 62/159,839, filed May 11, 2015, U.S. Provisional Application No. 62/173,248, filed Jun. 9, 2015, and U.S. Provisional Application No. 62/175,179, filed Jun. 12, 2015, the entire contents of each of which are incorporated by reference herein.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), ITU-T H.265, High Efficiency Video Coding (HEVC), and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video picture or a portion of a video picture) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized.

### SUMMARY

In one example, a method for decoding video data includes obtaining, from a coded video bitstream, a representation of a difference between a motion vector predictor and a motion vector that identifies a predictor block for a current block of video data in a current picture; obtaining, from the coded video bitstream, a syntax element that indicates whether adaptive motion vector resolution is used for the current block of video data; determining, based on the representation of the difference between the motion vector predictor and the motion vector that identifies the predictor block, a value of the motion vector; storing the value of the motion vector at fractional-pixel resolution regardless of whether adaptive motion vector resolution is used for the current block of video data and regardless of whether the predictor block is included in the current picture; determining, based on the value of the stored motion vector, pixel values of the predictor block; and reconstructing the current block based on the pixel values of the predictor block.

In another example, a method for encoding video data includes selecting a predictor block for a current block of video data in a current picture of video data; determining a value of a motion vector that identifies the selected predictor block for the current block; encoding, in a coded video bitstream, a representation of a difference between a motion vector predictor and the value of the motion vector; encoding, in the coded video bitstream, a syntax element that indicates whether adaptive motion vector resolution is used for the current block of video data; storing the value of the motion vector at fractional-pixel resolution regardless of whether adaptive motion vector resolution is used for the current block of video data and regardless of whether the predictor block is included in the current picture; determining, based on the value of the stored motion vector, pixel values of the predictor block; and reconstructing the current block based on the pixel values of the predictor block.

In another example, a device for decoding video data includes a memory configured to store a portion of the video data, and one or more processors. In this example, the one or more processors are configured to: obtain, from a coded video bitstream, a representation of a difference between a motion vector predictor and a motion vector that identifies a predictor block for a current block of video data in a current picture; obtain, from the coded video bitstream, a syntax element that indicates whether adaptive motion vector resolution is used for the current block of video data; determine, based on the representation of the difference between the motion vector predictor and the motion vector that identifies the predictor block, a value of the motion vector; store the value of the motion vector at fractional-pixel resolution regardless of whether adaptive motion vector resolution is used for the current block of video data and regardless of whether the predictor block is included in the current picture; determine, based on the value of the stored motion vector, pixel values of the predictor block; and reconstruct the current block based on the pixel values of the predictor block.

In another example, a device for encoding video data includes a memory configured to store a portion of the video data, and one or more processors. In this example, the one or more processors are configured to: select a predictor block for a current block of video data in a current picture of video data; determine a value of a motion vector that identifies the selected predictor block for the current block; encode, in a coded video bitstream, a representation of a difference between a motion vector predictor and the value of the motion vector; encode, in the coded video bitstream, a syntax element that indicates whether adaptive motion vector resolution is used for the current block of video data; store the value of the motion vector at fractional-pixel resolution regardless of whether adaptive motion vector resolution is used for the current block of video data and regardless of whether the predictor block is included in the current picture; determine, based on the value of the stored motion vector, pixel values of the predictor block; and reconstruct the current block based on the pixel values of the predictor block.

In another example, an apparatus for decoding video data includes means for obtaining, from a coded video bitstream, a representation of a difference between a motion vector predictor and a motion vector that identifies a predictor block for a current block of video data in a current picture; means for obtaining, from the coded video bitstream, a syntax element that indicates whether adaptive motion vector resolution is used for the current block of video data; means for determining, based on the representation of the difference between the motion vector predictor and the motion vector that identifies the predictor block, a value of the motion vector; means for storing the value of the motion vector at fractional-pixel resolution regardless of whether adaptive motion vector resolution is used for the current block of video data and regardless of whether the predictor block is included in the current picture; means for determining, based on the value of the stored motion vector, pixel values of the predictor block; and means for reconstructing the current block based on the pixel values of the predictor block.

In another example, an apparatus for encoding video data includes means for selecting a predictor block for a current block of video data in a current picture of video data; means for determining a value of a motion vector that identifies the selected predictor block for the current block; means for encoding, in a coded video bitstream, a representation of a difference between a motion vector predictor and the value of the motion vector; means for encoding, in the coded video bitstream, a syntax element that indicates whether adaptive motion vector resolution is used for the current block of video data; means for storing the value of the motion vector at fractional-pixel resolution regardless of whether adaptive motion vector resolution is used for the current block of video data and regardless of whether the predictor block is included in the current picture; means for determining, based on the value of the stored motion vector, pixel values of the predictor block; and means for reconstructing the current block based on the pixel values of the predictor block.

In another example, a computer-readable storage medium stores instructions that, when executed, cause one or more processors of a video decoding device to: obtain, from a coded video bitstream, a representation of a difference between a motion vector predictor and a motion vector that identifies a predictor block for a current block of video data in a current picture; obtain, from the coded video bitstream, a syntax element that indicates whether adaptive motion vector resolution is used for the current block of video data; determine, based on the representation of the difference between the motion vector predictor and the motion vector that identifies the predictor block, a value of the motion vector; store the value of the motion vector at fractional-pixel resolution regardless of whether adaptive motion vector resolution is used for the current block of video data and regardless of whether the predictor block is included in the current picture; determine, based on the value of the stored motion vector, pixel values of the predictor block; and reconstruct the current block based on the pixel values of the predictor block.

In another example, a computer-readable storage medium stores instructions that, when executed, cause one or more processors of a video encoding device to: select a predictor block for a current block of video data in a current picture of video data; determine a value of a motion vector that identifies the selected predictor block for the current block; encode, in a coded video bitstream, a representation of a difference between a motion vector predictor and the value of the motion vector; encode, in the coded video bitstream, a syntax element that indicates whether adaptive motion vector resolution is used for the current block of video data; store the value of the motion vector at fractional-pixel resolution regardless of whether adaptive motion vector resolution is used for the current block of video data and regardless of whether the predictor block is included in the current picture; determine, based on the value of the stored motion vector, pixel values of the predictor block; and reconstruct the current block based on the pixel values of the predictor block.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating an example video encoding and decoding system that may implement the techniques of this disclosure.

FIG. 2 is a conceptual diagram illustrating an example video sequence, in accordance with one or more techniques of this disclosure.

FIG. 3 is a block diagram illustrating an example of a video encoder that may use techniques for intra block copy described in this disclosure.

FIG. 4 is a block diagram illustrating an example of video decoder that may implement techniques described in this disclosure.

FIG. 5 is a diagram illustrating an example of an Intra Block Copying process, in accordance with one or more techniques of this disclosure.

FIG. 6 is a diagram illustrating example positions of spatial candidate positions, in accordance with one or more techniques of this disclosure.

FIG. 7 is a flowchart illustrating an example process for encoding a block of video data, in accordance with one or more techniques of this disclosure.

FIG. 8 is a flowchart illustrating an example process for decoding a block of video data, in accordance with one or more techniques of this disclosure.

### DETAILED DESCRIPTION

A video sequence is generally represented as a sequence of pictures. Typically, block-based coding techniques are used to code each of the individual pictures. That is, each picture is divided into blocks, and each of the blocks is individually coded. Coding a block of video data generally involves forming predicted values for pixels in the block and coding residual values. The prediction values are formed using pixel samples in one or more predictive blocks. The residual values represent the differences between the pixels of the original block and the predicted pixel values. Specifically, the original block of video data includes an array of pixel values, and the predicted block includes an array of predicted pixel values. The residual values represent to pixel-by-pixel differences between the pixel values of the original block and the predicted pixel values.

Prediction techniques for a block of video data are generally categorized as intra-prediction and inter-prediction. Intra-prediction, or spatial prediction, does not include prediction from any reference picture. Instead, the block is predicted from pixel values of neighboring, previously coded blocks. Inter-prediction, or temporal prediction, generally involves predicting the block from pixel values of one or more previously coded reference pictures (e.g., frames or slices) selected from one or more reference picture lists (RPLs). A video coder may include one or more reference picture buffers configured to store the pictures included in the RPLs.

Many applications, such as remote desktop, remote gaming, wireless displays, automotive infotainment, cloud computing, etc., are becoming routine in daily lives. Video contents in these applications are usually combinations of natural content, text, artificial graphics, etc. In text and artificial graphics region, repeated patterns (such as characters, icons, symbols, etc.) often exist. Intra Block Copying (Intra BC) is a technique which may enable a video coder to remove such redundancy and improve intra-picture coding efficiency. In some instances, Intra BC alternatively may be referred to as Intra motion compensation (MC).

According to some Intra BC techniques, video coders may use reconstructed pixels in a block of previously coded video data that is within the same picture as the current block of video data for prediction of the pixels of the current block. In some examples, the block of previously coded video data may be referred to as a predictor block or a predictive block. A video coder may use a motion vector to identify the predictor block. In some examples, the motion vector may also be referred to as a block vector, an offset vector, or a displacement vector. In some examples, a video coder may use a one-dimensional motion vector to identify the predictor block. Accordingly, some video coders may predict a current block of video data based on blocks of previously coded video data that share only the same set of x-values (i.e., vertically in-line with the current block) or the same set of y-values (i.e., horizontally in-line with the current block). In other examples, a video coder may use a two-dimensional motion vector to identify the predictor block. For instance, a video coder may use a two-dimensional motion vector that has a horizontal displacement component and a vertical displacement component, each of which may be zero or non-zero. The horizontal displacement component may represent a horizontal displacement between the predictor block of video data and a current block of video data and the vertical displacement component may represent a vertical displacement between the predictor block of video data and the current block of video data.

For Intra BC, the pixels of the predictor block may be used as predictive samples for corresponding pixels in the block (i.e., the current block) that is being coded. The video coder may additionally determine a residual block of video data based on the current block of video data and the prediction block, and code the two-dimensional motion vector and the residual block of video data.

In some examples, Intra BC may be an efficient coding tool, especially for screen content coding. For instance, in some examples, coding blocks using Intra BC may result in a smaller bitstream than the bitstream that would be produced by coding blocks using inter or intra coding. As discussed above, Intra BC is an inter-like coding tool (meaning that pixel values for a picture are predicted from other pixel values in the picture), but uses reference data from the same picture as the block being coded. In some examples, it may be difficult to integrate Intra BC into conventional intra pictures due to one or more constraints applied to Intra BC, which may not be preferred in practical design. Some example constraints include, but are not limited to, that the predictor block must be within the same slice or tile as the current block to be coded, that the predictor block must not overlap the current block to be coded, that all pixels in the predictor block must be reconstructed, that the predictor block be within a certain region (e.g., due to considerations relating to parallelization implementation as described in Rapaka et al., “On parallel processing capability of intra block copy,” Document: JCTVC-50220, JCT-VC of ITU-T SG 16 WP 3 and ISO/IEC JTC 1/SC 29/WG 11, 19^{th} Meeting: Strasbourg, FR 17-24 Oct. 2014) (hereinafter “JCTVC-S0220”), and, when constrained intra prediction is enabled, that the predictor block must not include any pixel coded using the conventional inter mode. Additionally, in some examples, the hardware architecture for conventional intra and inter frames may not be reused for Intra BC without modification (e.g., due to Intra BC resulting in block copy inside a picture). As such, it may be desirable to enable a video coder to gain the efficiencies provided by Intra BC while maintaining some or all of the constraints currently applied to Intra BC, and without (significant) modification to the hardware architecture.

In some examples, as opposed to predicting a block of a current picture based on samples in the current picture using conventional intra prediction techniques, a video coder may perform Intra BC to predict a block in a current picture based on samples in the current picture using techniques similar to conventional inter prediction. For instance, a video coder may include the current picture in a reference picture list (RPL) used to predict the current picture, store a version of the current picture (or at least the portion of the current picture that has been reconstructed) in a reference picture buffer, and code the block of video data in the current picture based on a predictor block of video data included in the version of the current picture stored in the reference picture buffer. In this way, a video coder may gain the efficiencies provided by Intra BC while maintaining some or all of the constraints currently applied to Intra BC. Also, in this way, a video coder may reuse the hardware architecture for conventional intra and inter frames for Intra BC without significant modification.

As discussed above, a video encoder may select a predictor block for a current block of video data from within the same picture. In some examples, a video encoder may evaluate several candidate predictor blocks and select the candidate predictor block that closely matches the current block, in terms of pixel difference, which may be determined by sum of absolute difference (SAD), sum of square difference (SSD), or other difference metrics.

In some examples, the motion vector used to identify the predictor block in the current picture may have integer-pixel resolution. For instance, the motion vector may include one or more whole numbers that represent the displacement between a current block and a predictor block in increments of a single pixel. As one example, a motion vector that has integer-pixel resolution may include a first integer (e.g., 3) that represents the horizontal displacement between a current block and a predictor block and a second integer (e.g., 2) that represents the vertical displacement between the current block and the predictor block.

In some examples, the motion vector used to identify the predictor block in the current picture may have fractional-pixel resolution. For instance, the motion vector may include one or more values that represent the displacement between a current block and a predictor block in increments of less than a single pixel. Some example resolutions that a fractional-pixel motion vector may have include, but are not necessarily limited to, half-pixel resolution (e.g., ½ pel resolution), quarter-pixel resolution (e.g., ¼ pel resolution), and eighth-pixel resolution (e.g., ⅛ pel resolution), etc. As one example, a motion vector that has quarter-pixel resolution may include a first value (e.g., 2.75) that represents the horizontal displacement between a current block and a predictor block and a second value (e.g., 2.5) that represents the vertical displacement between the current block and the predictor block.

As discussed above, the motion vector used to identify the predictor block may have different resolutions. In some examples, the resolution of the motion vector may be the resolution at which the motion vector is stored. As one example, if a video coder stores a motion vector with integer-pixel resolution, the motion vector may be considered to have integer-pixel resolution. As another example, if a video coder stores a motion vector with fractional-pixel resolution, the motion vector may be considered to have fractional-pixel resolution.

A video encoder may encode a representation of a motion vector. As one example, a video encoder may encode one or more syntax elements that represent the value of the motion vector. As another example, a video encoder may encode one or more syntax elements that represent a difference between the value of the motion vector and the value of a motion vector predictor, which may be a previously coded motion vector. In some examples, the one or more syntax elements may represent the difference between the value of the motion vector and the value of the motion vector predictor with integer-pixel resolution. In some examples, the one or more syntax elements may represent the difference between the value of the motion vector and the value of the motion vector predictor with fractional-pixel resolution. In some examples, the resolution of the motion vector predictor may be the same as the resolution at which the motion vector is stored.

Where the representation of the motion vector is encoded using one or more syntax elements that represent a difference between the value of the motion vector and the value of a motion vector predictor, a video coder may determine the value of the motion vector based on the value of the motion vector predictor and the value of the difference between the motion vector predictor and the motion vector. For instance, a video coder may add the value of the motion vector predictor and the value of the difference to determine the value of the motion vector. However, where the resolution of the difference is different than the resolution of the motion vector predictor, it may not be possible to simply add the value of the motion vector predictor and the value of the difference to determine the value of the motion vector. As such, where the resolution of the difference is different than the resolution of the motion vector predictor, a video coder may round one of the difference or the motion vector predictor before adding the values. For instance, where the motion vector predictor has fractional-pixel resolution and the difference has integer-pixel resolution, a video coder may round the motion vector predictor to integer-pixel resolution (e.g., right shift the motion vector predictor), add the rounded motion vector predictor to the difference, and store the result with fractional-pixel resolution (e.g., store a left-shifted version of the result).

In some examples, such as when the video data is screen content (e.g., video that is captured from a computer desktop), most of the motion vectors may have integer values (i.e., very few of the motion vectors point to fractional positions). Therefore, by using motion vectors with integer-pixel resolution, it may be possible for a video coder to reduce the number of bits needed to represent the video data without any significant impact on the quality of the encoded video data. The reduction in bits may be possible because, the number of bits needed to represent motion vectors with integer-pixel resolution may be one-fourth of the number of bits needed to represent motion vectors with quarter-pixel resolution. However, considering that motion vectors with fractional-pixel resolution may still be useful for camera-captured content, it may not be desirable to always use motion vectors with integer-pixel resolution. In some examples, to address this issue, the resolutions used by a video coder for motion vector storage and motion vector difference may be adaptive. For instance, as described in Li et al., “Adaptive motion vector resolution for screen content,” Joint Collaborative Team on Video Coding (JCT-VC) of ITU-T SG 16 WP 3 and ISO/IEC JTC 1/SC 29/WG 11, 19th Meeting: Strasbourg, FR, 17-24 Oct. 2014, Document: JCTVC-S0085, available at http://phenix.it-sudparis.eu/jct/doc_end_user/documents/19_Strasbourg/wg11/JCTVC-50085-v3.zip, for each slice, the motion vector can be stored, and the motion vector difference may be represented, with either integer-pixel resolution or fractional-pixel resolution (e.g., quarter-pixel resolution), and a syntax element (e.g., use_integer_mv_flag) may be coded in a slice header to indicate which motion vector resolution is used.

In some examples, when the syntax element indicates that adaptive motion vector resolution (AMVR) is not used, a video coder may use quarter-pixel resolution for both motion vector storage and motion vector difference representation. Similarly, when the syntax element indicates that AMVR is used, a video coder may use integer-pixel resolution for both motion vector storage and motion vector difference representation. Additionally, when the syntax element indicates that AMVR is used, a video coder may scale the motion vector before performing motion compensation (i.e., before identifying the predictor block indicated by the motion vector). For instance, a video coder may scale the motion vector by left shifting the motion vector by two before performing motion compensation. In this way, the video coder may always perform motion compensation using motion vectors with the same resolution.

In some examples, the resolutions used by a video coder for motion vector storage and motion vector difference may be different for motion vectors that identify predictor blocks in the current picture as compared to motion vectors that identify predictor blocks in different pictures. For instance, a video coder may use quarter-pixel resolution for motion vector difference for motion vectors that identify predictor blocks in different pictures and use integer pixel resolution for motion vector difference for motion vectors that identify predictor blocks in the current picture.

In some examples, the resolutions used by a video coder for motion vector storage and motion vector difference may be different depending on both whether a motion vector identifies a predictor block in the current picture or a different picture and whether AMVR is used. As one example, where AMVR is not used, a video coder may use quarter-pixel resolution for motion vector difference for motion vectors that identify predictor blocks in different pictures, use integer pixel resolution for motion vector difference for motion vectors that identify predictor blocks in the current picture, and store motion vectors with quarter-pixel resolution regardless of the location of the predictor block (i.e., independent of whether the predictor block is in the current picture or a different picture). As another example, where AMVR is used, a video coder may use integer-pixel resolution for motion vector storage for motion vectors that identify predictor blocks in different pictures, use quarter-pixel resolution for motion vector storage for motion vectors that identify predictor blocks in the current picture, and use integer-pixel resolution for motion vector difference regardless of the location of the predictor block (i.e., independent of whether the predictor block is in the current picture or a different picture).

Additionally, where AMVR is used, a video coder may scale motion vectors that identify predictor blocks in different pictures (i.e., that are stored with integer-pixel resolution) before performing motion compensation but not scale motion vectors that identify predictor blocks in the current picture (i.e., that are stored with quarter-pixel resolution) before performing motion compensation. In this way, the video coder may always perform motion compensation using motion vectors with the same resolution.

The above techniques for motion vector resolution may present one or more disadvantages. For instance, as discussed above and when AMVR is used, a video coder may store motion vectors that indicate predictor blocks in different pictures using a different resolution than motion vectors that indicate predictor blocks in the current picture. As a video coder may use previous MVs as motion vector predictors to determine future motion vectors, it may not be desirable for the previous motion vectors to be stored at different resolutions.

In accordance with one or more techniques of this disclosure, a video coder may store the value of a motion vector that identifies a predictor block for a current block in a current picture at a particular resolution regardless of whether AMVR is used for the current block and regardless of whether the predictor block is included in the current picture. For instance, a video coder may always store motion vectors with quarter-pixel resolution. By storing motion vectors that indicate predictor blocks in different pictures using the same resolution as motion vectors that indicate predictor blocks in the current picture, the techniques of this disclosure enable a video coder to use previous motion vectors that identify predictor blocks in either the current picture or a different picture as motion vector predictors for motion vectors that identify predictor blocks in either the current picture or a different picture without performing different processes when AMVR is used. In this way, the techniques of this disclosure may reduce the complexity of using predictor blocks in the current picture.

This disclosure describes example techniques related to utilizing a current picture as a reference picture when predicting portions of the current picture. To assist with understanding, the example techniques are described with respect to range extensions (RExt) to the High Efficiency Video Coding (HEVC) video coding standard, including the support of possibly high bit depth (e.g, more than 8 bit), different chroma sampling formats, including 4:4:4, 4:2:2, 4:2:0, 4:0:0 and the like. The techniques may also be applicable for screen content coding. It should be understood that the techniques are not limited to range extensions or screen content coding, and may be applicable generally to video coding techniques including standards based or non-standards based video coding. Also, the techniques described in this disclosure may become part of standards developed in the future. In other words, the techniques described in this disclosure may be applicable to previously developed video coding standards, video coding standards currently under development, and forthcoming video coding standards.

Recently, the design of a new video coding standard, namely High-Efficiency Video Coding (HEVC), has been finalized by the Joint Collaboration Team on Video Coding (JCT-VC) of ITU-T Video Coding Experts Group (VCEG) and ISO/IEC Motion Picture Experts Group (MPEG). The finalized HEVC specification, hereinafter referred to as HEVC version 1, is entitled ITU-T Telecommunication Standardization Sector of ITU, Series H: Audiovisual and Multimedia Systems, Infrastructure of Audiovisual Services-Coding of Moving Video: High Efficiency Video Coding, H.265, April 2015, is available from http://www.itu.int/rec/T-REC-H.265-201504-I. The Range Extensions to HEVC, namely HEVC RExt, are also being developed by the JCT-VC. A recent Working Draft (WD) of Range extensions, entitled High Efficiency Video Coding (HEVC) Range Extensions text specification: Draft 7, Joint Collaborative Team on Video Coding (JCT-VC) of ITU-T SG 16 WP 3 and ISO/IEC JTC 1/SC 29/WG 11, 17th Meeting: Valencia, ES, 27 Mar.-4 Apr. 2014, Document: JCTVC-Q1005_v4, hereinafter referred to as “RExt WD 7”, is available from http://phenix.int-evey.fr/jct/doc_end_user/documents/17_Valencia/wg11/JCTVC-Q1005-v4.zip.

The range extension specification may become version 2 of the HEVC specification. However, in a large extent, as far as the proposed techniques are concerned, e.g., motion vector (MV) prediction, HEVC version 1 and the range extension specification are technically similar. Therefore whenever changes are referred to as based on HEVC version 1, the same changes may apply to the range extension specification, and whenever the HEVC version 1 module is described, the description may also be applicable to the HEVC range extension module (with the same sub-clauses).

Recently, investigation of new coding tools for screen-content material such as text and graphics with motion was requested, and technologies that improve the coding efficiency for screen content have been proposed. Because there is evidence that significant improvements in coding efficiency can be obtained by exploiting the characteristics of screen content with novel dedicated coding tools, a Call for Proposals (CfP) is being issued with the target of possibly developing future extensions of the High Efficiency Video Coding (HEVC) standard including specific tools for screen content coding (SCC). A recent Working Draft (WD) of the SCC Specification, High Efficiency Video Coding (HEVC) Screen Content Coding: Draft 5, Joint Collaborative Team on Video Coding (JCT-VC) of ITU-T SG 16 WP 3 and ISO/IEC JTC 1/SC 29/WG 11, 22nd Meeting: Geneva, CH, 15-21 Oct. 2015, Document: JCTVC-V1005, hereinafter referred to as “SCC WD 5”, is available from http://phenix.it-sudparis.eu/jct/doc_end_user/documents/22_Geneva/wg11/JCTVC-V1005-v1.zip. A previous WD of the SCC Specification, High Efficiency Video Coding (HEVC) Screen Content Coding: Draft 3, Joint Collaborative Team on Video Coding (JCT-VC) of ITU-T SG 16 WP 3 and ISO/IEC JTC 1/SC 29/WG 11, 20th Meeting: Geneva, CH, 10 Feb. —17 Feb. 2015, Document: JCTVC-T1005, hereinafter referred to as “SCC WD 3”, is available from http://phenix.it-sudparis.eu/jct/doc_end_user/documents/22_Geneva/wg11/JCTVC-T1005-v2.zip.

In the description and some examples, motion vector (MV) rounding may be used. Certain rounding methods are provided as an example in the description, and other MV rounding procedures can be applied instead. For example, an MV can be just rounded to some integer MV, to the nearest MV, to the nearest smallest MV, and etc. . . . During rounding, the sign of the MV components can be considered, for example for the negative components the rounding can be done towards zero. Rounding offset can be added prior to rounding procedure, the offset can be equal to half of the denominator (representing 0.5), half of the denominator minus 1, or any value is general. In this disclosure, MV>>2 or (MV>>2)<<2 may denote downscaling or rounding, and everything said above can be applied replacing the operation used in the disclosure.

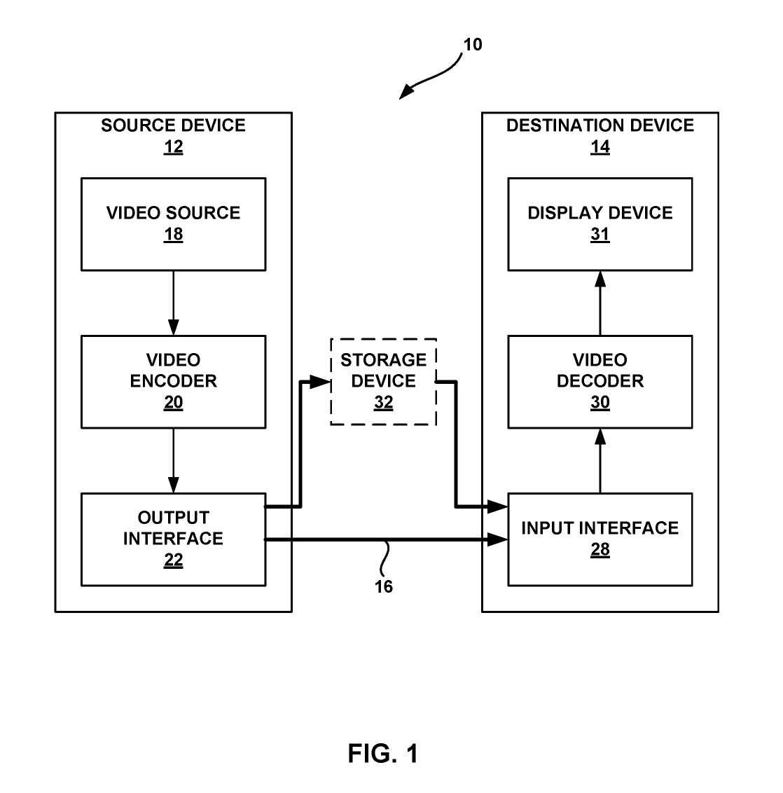

FIG. 1 is a block diagram illustrating an example video encoding and decoding system 10 that may implement the techniques of this disclosure. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 of source device 12 to a storage device 32. Similarly, encoded data may be accessed from the storage device 32 by input interface 28 of destination device 14. The storage device 32 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device 32 may correspond to a file server or another intermediate storage device that may store the encoded video generated by source device 12.

Destination device 14 may access stored video data from the storage device 32 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 31. In accordance with this disclosure, video encoder 20 of source device 12 may be configured to apply the techniques for performing transformation in video coding. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for improved intra block copy signaling in video coding may be performed by any digital video encoding and/or decoding device. Although generally the techniques of this disclosure are performed by a video encoding or decoding device, the techniques may also be performed by a combined video codec. Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 includes video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16 or storage device 32. The information of computer-readable medium 16 or storage device 32 may include syntax information defined by video encoder 20, which is also used by video decoder 30, that includes syntax elements that describe characteristics and/or processing of blocks and other coded units, e.g., GOPs. Display device 31 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined video encoder/decoder (codec). A device including video encoder 20 and/or video decoder 30 may comprise an integrated circuit, a microprocessor, and/or a wireless communication device, such as a cellular telephone.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

This disclosure may generally refer to video encoder 20 “signaling” certain information to another device, such as video decoder 30. It should be understood, however, that video encoder 20 may signal information by associating certain syntax elements with various encoded portions of video data. That is, video encoder 20 may “signal” data by storing certain syntax elements to headers of various encoded portions of video data. In some cases, such syntax elements may be encoded and stored (e.g., stored to storage device 32) prior to being received and decoded by video decoder 30. Thus, the term “signaling” may generally refer to the communication of syntax or other data for decoding compressed video data, whether such communication occurs in real- or near-real-time or over a span of time, such as might occur when storing syntax elements to a medium at the time of encoding, which then may be retrieved by a decoding device at any time after being stored to this medium.

Video encoder 20 and video decoder 30 may operate according to a video compression standard, such as the HEVC standard. While the techniques of this disclosure are not limited to any particular coding standard, the techniques may be relevant to the HEVC standard, and particularly to the extensions of the HEVC standard, such as the SCC extension.

In general, HEVC describes that a video picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive coding tree units (CTUs). Each of the CTUs may comprise a coding tree block (CTB) of luma samples, two corresponding coding tree blocks of chroma samples, and syntax structures used to code the samples of the coding tree blocks. In a monochrome picture or a picture that have three separate color planes, a CTU may comprise a single coding tree block and syntax structures used to code the samples of the coding tree block.

A video picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs. A CU may comprise a coding block of luma samples and two corresponding coding blocks of chroma samples of a picture that has a luma sample array, a Cb sample array and a Cr sample array, and syntax structures used to code the samples of the coding blocks. In a monochrome picture or a picture that have three separate color planes, a CU may comprise a single coding block and syntax structures used to code the samples of the coding block. A coding block is an N×N block of samples.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs.

In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. A prediction block may be a rectangular (i.e., square or non-square) block of samples on which the same prediction is applied. A PU of a CU may comprise a prediction block of luma samples, two corresponding prediction blocks of chroma samples of a picture, and syntax structures used to predict the prediction block samples. In a monochrome picture or a picture that have three separate color planes, a PU may comprise a single prediction block and syntax structures used to predict the prediction block samples.

TUs may include coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU. A transform block may be a rectangular block of samples on which the same transform is applied. A transform unit (TU) of a CU may comprise a transform block of luma samples, two corresponding transform blocks of chroma samples, and syntax structures used to transform the transform block samples. In a monochrome picture or a picture that have three separate color planes, a TU may comprise a single transform block and syntax structures used to transform the transform block samples.

Following transformation, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Video encoder 20 may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan.

After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

Video encoder 20 may further send syntax data, such as block-based syntax data, picture-based syntax data, and group of pictures (GOP)-based syntax data, to video decoder 30, e.g., in a picture header, a block header, a slice header, or a GOP header. The GOP syntax data may describe a number of pictures in the respective GOP, and the picture syntax data may indicate an encoding/prediction mode used to encode the corresponding picture.

Video decoder 30, upon obtaining the coded video data, may perform a decoding pass generally reciprocal to the encoding pass described with respect to video encoder 20. For example, video decoder 30 may obtain an encoded video bitstream that represents video blocks of an encoded video slice and associated syntax elements from video encoder 20. Video decoder 30 may reconstruct the original, unencoded video sequence using the data contained in the bitstream.

Video encoder 20 and video decoder 30 may perform intra- and inter-coding of video blocks within video slices. Intra-coding relies on spatial prediction to reduce or remove spatial redundancy in video within a given video picture. Inter-coding relies on temporal prediction or inter-view prediction to reduce or remove temporal redundancy in video within adjacent pictures of a video sequence or reduce or remove redundancy with video in other views. Intra-mode (I mode) may refer to any of several spatial based compression modes. Inter-modes, such as uni-directional prediction (P mode) or bi-prediction (B mode), may refer to any of several temporal-based compression modes.

In some examples, such as when coding screen content, video encoder 20 and/or video decoder 30 may perform Intra BC using techniques similar to conventional inter prediction. For instance, to encode a current block of a current picture of video data, video encoder 20 may select a predictor block of video data included in a version of the current picture stored in a reference picture buffer, encode a motion vector that identifies the position of the predictor block relative to the current block in the current picture, and encode a residual block of video data that represents difference between the current block of video data and the predictor block.

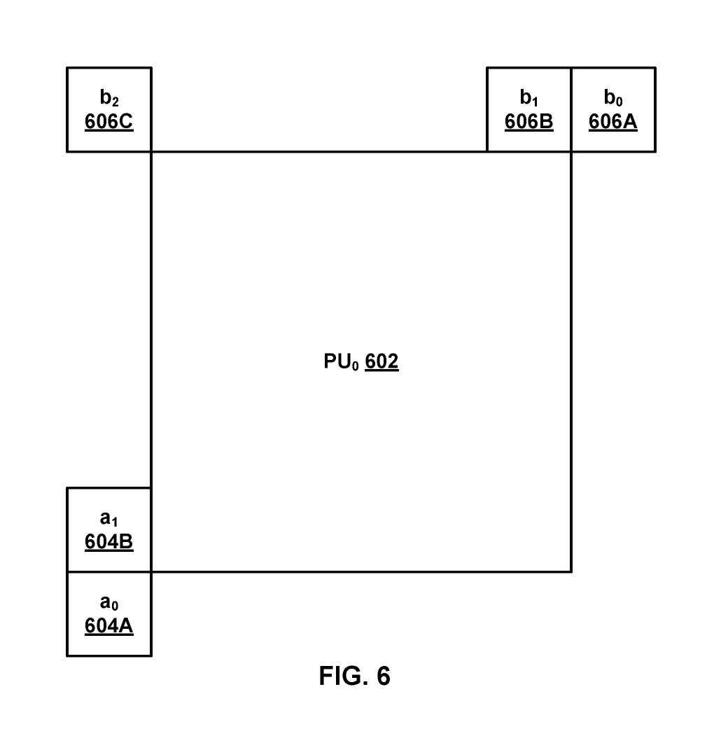

As discussed above, video encoder 20 may encode a representation of a motion vector that identifies the position of the predictor block relative to the current block. As one example, video encoder 20 may encode one or more syntax elements that represent the value of the motion vector. As another example, video encoder 20 may encode one or more syntax elements that represent a difference between the value of the motion vector and the value of a motion vector predictor, sometimes referred to as the motion vector difference or MVD. In some examples, the motion vector predictor may be a previously coded motion vector, such as the motion vector of a neighboring block. Further details of the use of motion vector predictors are discussed below with reference to FIG. 6.

As discussed above, in some examples, the resolutions used by a video coder for the MVD may be adaptive. For instance, video encoder 20 and/or video decoder 30 may selectively use either integer-pixel resolution or fractional-pixel resolution to represent the MVD. In some examples, video encoder 20 may encode and/or video decoder 30 may decode a syntax element that indicates whether adaptive motion vector resolution (AMVR) is used. For instance, video encoder 20 may encode and/or video decoder 30 may decode a syntax element (e.g., use_integer_mv_flag) that indicates whether the MVD is represented using integer-pixel resolution or fractional-pixel resolution. Additionally, when the syntax element indicates that AMVR is used, video encoder 20 and/or video decoder 30 may scale the motion vector before performing motion compensation (i.e., before identifying the predictor block indicated by the motion vector). For instance, video encoder 20 and/or video decoder 30 may scale the motion vector by left shifting the motion vector by two before performing motion compensation.

In SCC Draft 3, the resolution of the MVD and the location of the predictor block identified by the motion vector may dictate the resolution at which the motion vector is stored. For instance, if an MVD has integer-pixel resolution and the predictor block identified by the MV is in a different picture, an SCC Draft 3 compliant video coder may store the motion vector with integer-pixel resolution. Otherwise, if the MVD has quarter-pixel resolution or the predictor block identified by the motion vector is in the current picture, an SCC Draft 3 compliant video coder may store the motion vector with quarter-pixel resolution.

In some examples, the differing storage resolutions may not present any problems. For instance, if an MVD has integer-pixel resolution, the predictor block identified by the motion vector is in a different picture, and the motion vector predictor has integer-pixel resolution, a video coder may determine the motion vector by simply adding the value of the MVD to the value of the motion vector predictor. However, if the motion vector predictor for the same motion vector has quarter-pixel resolution, the video coder may need to process the motion vector predictor before determining the motion vector. For instance, the video coder may need to determine that the motion vector predictor has a different resolution than the MVD, round the value of the motion vector predictor to integer-pixel resolution, and add the value of the MVD to the rounded value of the motion vector predictor to determine the value of the motion vector. This differing treatment may introduce undesirable complexity to the video coder.

In accordance with one or more techniques of this disclosure, as opposed to storing motion vectors at different resolutions based on the location of the predictor block and whether AMVR is used, video encoder 20 and/or video decoder 30 may store the value of a motion vector that identifies a predictor block for a current block in a current picture at a particular resolution regardless of whether AMVR is used for the current block and regardless of whether the predictor block is included in the current picture. For instance, video encoder 20 and/or video decoder 30 may always store motion vectors with quarter-pixel resolution. By storing motion vectors that indicate predictor blocks in different pictures using the same resolution as motion vectors that indicate predictor blocks in the current picture, the techniques of this disclosure may enable video encoder 20 and/or video decoder 30 to use previous motion vectors that identify predictor blocks in either the current picture or a different picture as motion vector predictors for motion vectors that identify predictor blocks in either the current picture or a different picture without performing different processes when AMVR is used. Additionally, by always storing motion vectors with the same resolution, video encoder 20 and/or video decoder 30 may avoid having to scale motion vectors prior to performing motion compensation. In this way, the techniques of this disclosure may reduce the complexity of using predictor blocks in the current picture.

In some examples, such as where the motion vector has integer-pixel resolution, the sample pixel values identified by the motion vector may fall at integer-pixel positions and thus, video encoder 20 and/or video decoder 30 may access said sample pixel values without interpolation. As video encoder 20 and/or video decoder 30 may access the sample pixels without interpolation, video encoder 20 and/or video decoder 30 may only use sample pixel values located inside the predictor block to predict the current block where the motion vector has integer-pixel resolution. In some examples, such as where the motion vector has fractional-pixel resolution, the sample pixel values identified by the motion vector may not fall at integer-pixel positions and thus, video encoder 20 and/or video decoder 30 may need to perform interpolation to construct said sample pixel values. In some examples, to perform interpolation to construct the sample pixels, video encoder 20 and/or video decoder 30 may need to use sample pixel values located both inside and outside the predictor block to predict the current block. However, in some examples, it may not be desirable for video encoder 20 and/or video decoder 30 to use sample pixel values located outside a predictor block to predict a current block. For instance, when the predictor block and the current block are located in the current picture, it may not be possible for video decoder 30 to use sample pixel values located outside the predictor block because such samples may not be available (i.e., may not be located in the reconstructed region of the current picture).

In accordance with one or more techniques of this disclosure, video encoder 20 may select a predictor block for a current block from within a search region determined based on a resolution to be used for a motion vector that identifies the predictor block. For instance, video encoder 20 may use a smaller search region when the resolution to be used for the motion vector is fractional-pixel precision than then when the resolution to be used for the motion vector is integer-pixel precision. As one example, when the resolution to be used for the motion vector is integer-pixel, video encoder 20 may select the predictor block from within an initial search region that includes a reconstructed region of the current picture. As another example, when the resolution to be used for the motion vector is fractional-pixel, video encoder 20 may select the predictor block from within a reduced search region that is determined by reducing the size of the initial search region by M samples from right and bottom boundaries of the initial search region and reducing the size of the initial search region by N samples from top and left boundaries of the initial search region. In this way, video encoder 20 may ensure that all sample pixel values needed to construct the predictor block, including sample pixel values located outside the predictor block, are available for use by video decoder 30 when decoding the current block based on the predictor block. As such, video encoder 20 may avoid an encoder/decoder mismatch.

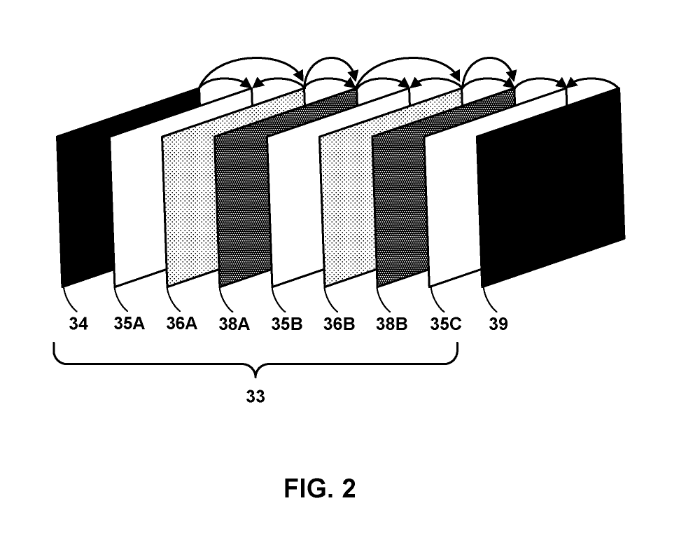

FIG. 2 is a conceptual diagram illustrating an example video sequence 33 that includes pictures 34, 35A, 36A, 38A, 35B, 36B, 38B, and 35C, in display order. One or more of these pictures may include P-slices, B-slices, or I-slices. In some cases, video sequence 33 may be referred to as a group of pictures (GOP). Picture 39 is a first picture in display order for a sequence occurring after video sequence 33. FIG. 2 generally represents an example prediction structure for a video sequence and is intended only to illustrate the picture references used for encoding different inter-predicted slice types. An actual video sequence may contain more or fewer video pictures that include different slice types and in a different display order.

For block-based video coding, each of the video pictures included in video sequence 33 may be partitioned into video blocks or coding units (CUs). Each CU of a video picture may include one or more prediction units (PUs). In some examples, the prediction methods available to predict PUs within a picture may depend on the picture type. As one example, video blocks or PUs in slices of an intra-predicted picture (an I-picture) may be predicted using intra-prediction modes (i.e., spatial prediction with respect to neighboring blocks in the same picture). As another example, video blocks or PUs in slices of an inter-predicted picture (a B-picture or a P-picture) may be predicted using inter or intra-prediction modes (i.e., spatial prediction with respect to neighboring blocks in the same picture or temporal prediction with respect to other reference pictures). In other words, an I-picture may include I-slices, a P-picture may include both I-slices and P-slices, and a B-picture may include I-slices, P-slices, and B-slices.

Video blocks of a P-slice may be encoded using uni-directional predictive coding from a reference picture identified in a reference picture list. Video blocks of a B-slice may be encoded using bi-directional predictive coding from multiple reference picture identified in multiple reference picture lists.

In the example of FIG. 2, first picture 34 is designated for intra-mode coding as an I-picture. In other examples, first picture 34 may be coded with inter-mode coding, e.g., as a P-picture, or B-picture, with reference to a first picture of a preceding sequence. Video pictures 35A-35C (collectively “video pictures 35”) are designated for coding as B-pictures using bi-prediction with reference to a past picture and a future picture. As illustrated in the example of FIG. 2, picture 35A may be encoded as a B-picture with reference to first picture 34 and picture 36A, as indicated by the arrows from picture 34 and picture 36A to video picture 35A. In the example of FIG. 2, first picture 34 and picture 36A may be included in reference picture lists used during prediction of blocks of picture 35A. Pictures 35B and 35C are similarly encoded.

Video pictures 36A-36B (collectively “video pictures 36”) may be designated for coding as P-pictures, or B-pictures, using uni-direction prediction with reference to a past picture. As illustrated in the example of FIG. 2, picture 36A is encoded as a P-picture, or B-picture, with reference to first picture 34, as indicated by the arrow from picture 34 to video picture 36A. Picture 36B is similarly encoded as a P-picture, or B-picture, with reference to picture 38A, as indicated by the arrow from picture 38A to video picture 36B.

Video pictures 38A-38B (collectively “video pictures 38”) may be designated for coding as P-pictures, or B-pictures, using uni-directional prediction with reference to the same past picture. As illustrated in the example of FIG. 2, picture 38A is encoded with two references to picture 36A, as indicated by the two arrows from picture 36A to video picture 38A. Picture 38B is similarly encoded.

In some examples, each of the pictures may be assigned a unique value (that is, a value that is unique to a particular video sequence, e.g., a sequence of pictures following an instantaneous decoder refresh (IDR) picture in decoding order) that indicates the order in which the pictures are to be output. This unique value may be referred to as the picture order count (POC). In some examples, the order in which the pictures are to be output may be different than the order in which the pictures are coded. For instance, picture 35A may be output before picture 36A while picture 36A may be coded before picture 35A.

In some examples, a video coder (e.g., video encoder 20 or video decoder 30) may perform Intra BC by inserting a current picture in a reference picture list (RPL) used to predict blocks in the current picture. For instance, in the example of FIG. 2, a video coder may insert an indication of picture 35A, along with indications of picture 34 and picture 36A, in RPLs used to predict blocks in picture 35A. The video coder may then use picture 35A as a reference picture when coding blocks of picture 35A.

In accordance with one or more techniques of this disclosure, as opposed to storing motion vectors at different resolutions based on the location of the predictor block and whether AMVR is used, a video coder may store the value of a motion vector that identifies a predictor block for a current block in a current picture at a particular resolution regardless of whether AMVR is used for the current block and regardless of whether the predictor block is included in the current picture.

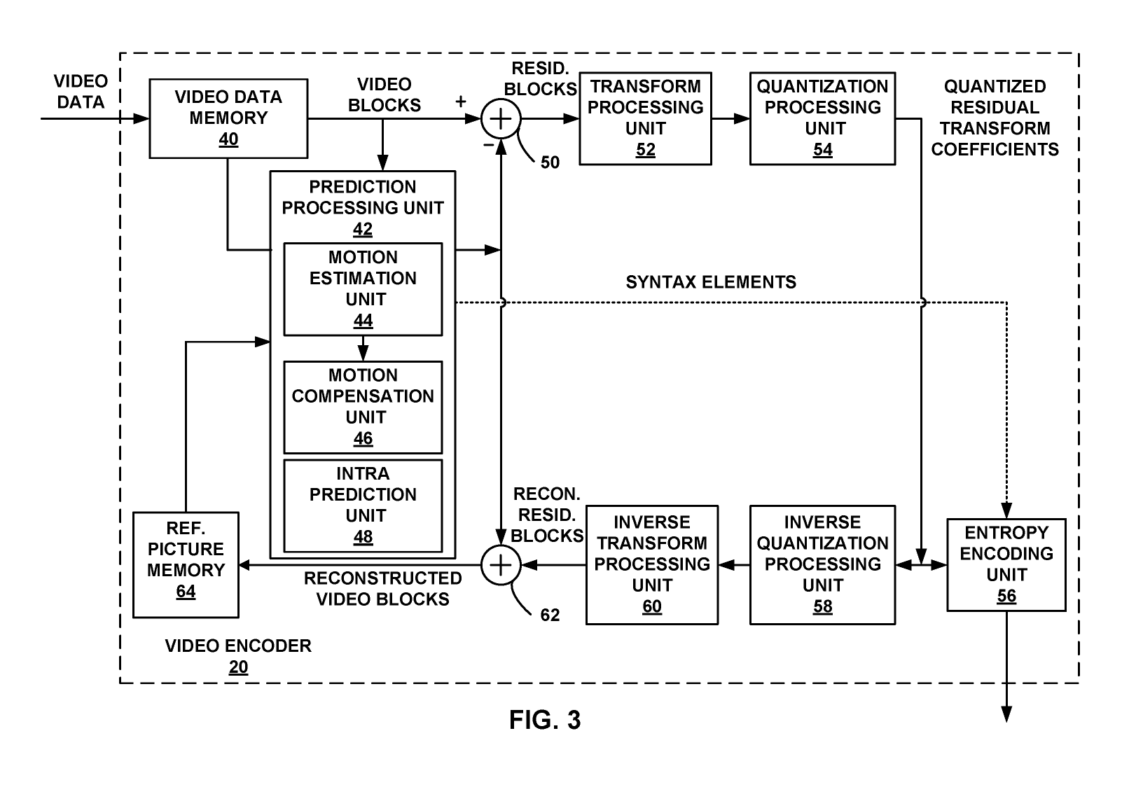

FIG. 3 is a block diagram illustrating an example of a video encoder 20 that may use techniques for intra block copy described in this disclosure. The video encoder 20 will be described in the context of HEVC coding for purposes of illustration, but without limitation of this disclosure as to other coding standards. Moreover, video encoder 20 may be configured to implement techniques in accordance with the range extensions of HEVC.

Video encoder 20 may perform intra- and inter-coding of video blocks within video slices. Intra-coding relies on spatial prediction to reduce or remove spatial redundancy in video within a given video picture. Inter-coding relies on temporal prediction or inter-view prediction to reduce or remove temporal redundancy in video within adjacent pictures of a video sequence or reduce or remove redundancy with video in other views.

In the example of FIG. 3, video encoder 20 may include video data memory 40, prediction processing unit 42, reference picture memory 64, summer 50, transform processing unit 52, quantization processing unit 54, and entropy encoding unit 56. Prediction processing unit 42, in turn, includes motion estimation unit 44, motion compensation unit 46, and intra-prediction unit 48. For video block reconstruction, video encoder 20 also includes inverse quantization processing unit 58, inverse transform processing unit 60, and summer 62. A deblocking filter (not shown in FIG. 3) may also be included to filter block boundaries to remove blockiness artifacts from reconstructed video. If desired, the deblocking filter would typically filter the output of summer 62. Additional loop filters (in loop or post loop) may also be used in addition to the deblocking filter.

Video data memory 40 may store video data to be encoded by the components of video encoder 20. The video data stored in video data memory 40 may be obtained, for example, from video source 18. Reference picture memory 64 is one example of a decoding picture buffer (DPB) that stores reference video data for use in encoding video data by video encoder 20 (e.g., in intra- or inter-coding modes, also referred to as intra- or inter-prediction coding modes). Video data memory 40 and reference picture memory 64 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 40 and reference picture memory 64 may be provided by the same memory device or separate memory devices. In various examples, video data memory 40 may be on-chip with other components of video encoder 20, or off-chip relative to those components.

During the encoding process, video encoder 20 receives a video picture or slice to be coded. The picture or slice may be divided into multiple video blocks. Motion estimation unit 44 and motion compensation unit 46 perform inter-predictive coding of the received video block relative to one or more blocks in one or more reference pictures to provide temporal compression or provide inter-view compression. Intra-prediction unit 48 may alternatively perform intra-predictive coding of the received video block relative to one or more neighboring blocks in the same picture or slice as the block to be coded to provide spatial compression. Video encoder 20 may perform multiple coding passes (e.g., to select an appropriate coding mode for each block of video data).

Moreover, a partition unit (not shown) may partition blocks of video data into sub-blocks, based on evaluation of previous partitioning schemes in previous coding passes. For example, the partition unit may initially partition a picture or slice into LCUs, and partition each of the LCUs into sub-CUs based on rate-distortion analysis (e.g., rate-distortion optimization). Prediction processing unit 42 may further produce a quadtree data structure indicative of partitioning of an LCU into sub-CUs. Leaf-node CUs of the quadtree may include one or more PUs and one or more TUs.

Prediction processing unit 42 may select one of the coding modes, intra or inter, e.g., based on error results, and provides the resulting intra- or inter-coded block to summer 50 to generate residual block data and to summer 62 to reconstruct the encoded block for use as a reference picture. Prediction processing unit 42 also provides syntax elements, such as motion vectors, intra-mode indicators, partition information, and other such syntax information, to entropy encoding unit 56.

Motion estimation unit 44 and motion compensation unit 46 may be highly integrated, but are illustrated separately for conceptual purposes. Motion estimation, performed by motion estimation unit 44, is the process of generating motion vectors, which estimate motion for video blocks. A motion vector, for example, may indicate the displacement of a PU of a video block within a current video picture relative to a predictive block within a reference picture (or other coded unit) relative to the current block being coded within the current picture (or other coded unit). A predictive block is a block that is found by video encoder 20 to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 44 may perform a motion search relative to the full pixel positions and fractional pixel positions and output a motion vector with either integer-pixel precision or fractional-pixel precision.

Motion estimation unit 44 calculates a motion vector for a PU of a video block in an inter-coded slice by comparing the position of the PU to the position of a predictive block of a reference picture. The reference picture may be selected from one or more reference picture lists (RPLs) which identify one or more reference pictures stored in reference picture memory 64. Motion estimation unit 44 sends the calculated motion vector to entropy encoding unit 56 and motion compensation unit 46. In some examples, motion estimation unit 44 may send an indication of the selected reference picture to entropy encoding unit 56.

As discussed above, motion estimation unit 44 may send an indication of the selected reference picture to entropy encoding unit 56. In some examples, motion estimation unit 44 may send the indication by sending the index value of the selected reference picture within the RPL.

In some examples, as opposed to restricting inter-prediction to use other pictures as reference pictures, motion estimation unit 44 may use a current picture as a reference picture to predict blocks of video data included in the current picture. For example, motion estimation unit 44 may store a version of a current picture in reference picture memory 64. In some examples, motion estimation unit 44 may store an initialized version of the current picture with pixel values initialized to a fixed value. In some examples, the fixed value may be based on a bit depth of samples of the current picture. For instance, the fixed value may be 1<<(bitDepth−1). In some examples, motion estimation unit 44 may store the initialized version of the current picture before encoding any blocks of the current picture. By storing an initialized version of the current picture, motion estimation unit 44 may not be required to constrain the search for predictive blocks (i.e., a search region) to blocks that are already reconstructed. By contrast, if motion estimation unit 44 does not store an initialized version of the current picture, the search for predictive blocks may be constrained to blocks that are already reconstructed to, for example, avoid a decoder/encoder mismatch.

Prediction processing unit 42 may generate one or more RPLs for the current picture. For instance, prediction processing unit 42 may include the current picture in an RPL for the current picture.

As discussed above, when encoding a block of video data of a current picture of video data, motion estimation unit 44 may select a predictive block that closely matches the current block. In some examples, as opposed to (or in addition to) searching blocks of other pictures, motion estimation unit 44 may select a block located in the current picture for use as a predictive block for the current block of the current picture. For example, motion estimation unit 44 may perform a search on pictures including one or more reference pictures, including the current picture. For each picture, motion estimation unit 44 may calculate search results reflecting how well a predicted block matches the current block, e.g., using pixel-by-pixel sum of absolute differences (SAD), sum of squared differences (SSD), mean absolute difference (MAD), mean squared difference (MSD), or the like. Then, motion estimation unit 44 may identify a block in a picture having the best match to the current block, and indicate the position of the block and the picture (which may be the current picture) to prediction processing unit 42. In this way, motion estimation unit 44 may perform Intra BC, e.g., when motion estimation unit 44 determines that a predictor block is included in the current picture, that is, the same picture as the current block being predicted.

Motion compensation, performed by motion compensation unit 46, may involve fetching or generating the predictive block based on the motion vector determined by motion estimation unit 44. Again, motion estimation unit 44 and motion compensation unit 46 may be functionally integrated, in some examples. Upon receiving the motion vector for the PU of the current block, motion compensation unit 46 may locate the predictive block to which the motion vector points in one of the reference picture lists (RPLs). Summer 50 forms a residual video block by subtracting pixel values of the predictive block from the pixel values of the current block being coded, forming pixel difference values, as discussed below. In general, motion estimation unit 44 performs motion estimation relative to luma components, and motion compensation unit 46 uses motion vectors calculated based on the luma components for both chroma components and luma components. Prediction processing unit 42 may also generate syntax elements associated with the video blocks and the video slice for use by video decoder 30 in decoding the video blocks of the video slice.

As discussed above, video encoder 20 may encode a representation of a motion vector that identifies the position of the predictor block relative to the current block. As one example, motion compensation unit 46 may cause entropy encoding unit 56 to encode one or more syntax elements that represent the value of the motion vector. As another example, motion compensation unit 46 may cause entropy encoding unit 56 to encode one or more syntax elements that represent a difference between the value of the motion vector and the value of a motion vector predictor, sometimes referred to as the motion vector difference or MVD. In some examples, the motion vector predictor may be a previously coded motion vector, such as the motion vector of a neighboring block. Further details of the use of motion vector predictors are discussed below with reference to FIG. 6.

As discussed above, in some examples, the resolutions used by video encoder 20 for MVD may be adaptive. For instance, motion compensation unit 46 may selectively use either integer-pixel resolution or fractional-pixel resolution to represent the MVD. In some examples, motion compensation unit 46 may cause entropy encoding unit 56 to encode a syntax element that indicates whether adaptive motion vector resolution (AMVR) is used. For instance, motion compensation unit 46 may cause entropy encoding unit 56 to encode a syntax element (e.g., use_integer_mv_flag) that indicates whether the MVD is represented using integer-pixel resolution or fractional-pixel resolution. Additionally, when AMVR is used, motion compensation unit 46 may scale the motion vector before performing motion compensation (i.e., before identifying the predictor block indicated by the motion vector). For instance, motion compensation unit 46 may scale the motion vector by left shifting the motion vector by two before performing motion compensation

As discussed above, in some examples, the resolution of the MVD and the location of the predictor block identified by the motion vector may dictate the resolution at which motion compensation unit 46 stores the motion vector. However, in some examples, storing motion vectors with different resolutions may introduce undesirable complexity to video encoder 20.

In accordance with one or more techniques of this disclosure, as opposed to storing motion vectors at different resolutions based on the location of the predictor block and whether AMVR is used, video encoder 20 may store the value of a motion vector that identifies a predictor block for a current block in a current picture at a particular resolution regardless of whether AMVR is used for the current block and regardless of whether the predictor block is included in the current picture. For instance, motion compensation unit 46 may always store motion vectors with quarter-pixel resolution. By storing motion vectors that indicate predictor blocks in different pictures using the same resolution as motion vectors that indicate predictor blocks in the current picture, the techniques of this disclosure may enable motion compensation unit 46 to use previous motion vectors that identify predictor blocks in either the current picture or a different picture as motion vector predictors for motion vectors that identify predictor blocks in either the current picture or a different picture without performing different processes when AMVR is used. Additionally, by always storing motion vectors with the same resolution, motion compensation unit 46 may avoid having to scale motion vectors prior to performing motion compensation. In this way, the techniques of this disclosure may reduce the complexity of using predictor blocks in the current picture.

Intra-prediction unit 48 may intra-predict a current block, as an alternative to the inter-prediction performed by motion estimation unit 44 and motion compensation unit 46, as described above. In particular, intra-prediction unit 48 may determine an intra-prediction mode to use to encode a current block. In some examples, intra-prediction unit 48 may encode blocks using various intra-prediction modes, e.g., during separate encoding passes, and intra-prediction unit 48 may select an appropriate intra-prediction mode to use from a plurality of intra-prediction modes.

For example, intra-prediction unit 48 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 48 may calculate ratios from the distortions and rates for the various encoded blocks to determine which intra-prediction mode exhibits the best rate-distortion value for the block.

In some examples, the plurality of intra-prediction modes available for use by intra-prediction unit 48 may include a planar prediction mode, a DC prediction mode, and one or more angular prediction modes. Regardless of the selected mode, intra-prediction unit 48 may always predict a current block based on reconstructed blocks adjacent to the current block. As one example, when using the planar prediction mode, intra-prediction unit 48 may predict a current block by averaging horizontal and vertical predictions. In some examples, intra-prediction unit 48 may determine the horizontal predictions based on a left neighboring block and a top-right neighboring block (as samples of the right neighboring block may not be reconstructed when predicting the current block) and determine the vertical predictions based on a top neighboring block and a bottom-left neighboring block (as samples of the bottom neighboring block may not be reconstructed when predicting the current block).

As another example, when using the DC prediction mode, intra-prediction unit 48 may predict samples of a current block with a constant value. In some examples, the constant value may represent an average of samples in the left-neighboring block and samples in the top neighboring block. As another example, when using one of the one or more angular prediction modes, intra-prediction unit 48 may predict samples of a current block based on samples from a neighboring block indicated by a prediction direction.

Video encoder 20 forms a residual video block by subtracting the prediction data from prediction processing unit 42 from the original video block being coded. Summer 50 represents the component or components that perform this subtraction operation.

Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain.

Transform processing unit 52 may send the resulting transform coefficients to quantization processing unit 54. Quantization processing unit 54 quantizes the transform coefficients to further reduce bit rate. The quantization process may reduce the bit depth associated with some or all of the coefficients. The degree of quantization may be modified by adjusting a quantization parameter. In some examples, quantization processing unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive binary arithmetic coding (CABAC), context adaptive variable length coding (CAVLC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization processing unit 58 and inverse transform processing unit 60 apply inverse quantization and inverse transformation, respectively, to reconstruct the residual block in the pixel domain, e.g., for later use as a reference block.

Motion compensation unit 46 may also apply one or more interpolation filters to the reference block to calculate sub-integer pixel values for use in motion estimation. Summer 62 adds the reconstructed residual block to the motion compensated prediction block produced by motion compensation unit 46 to produce a reconstructed video block for storage in reference picture memory 64. The reconstructed video block may be used by motion estimation unit 44 and motion compensation unit 46 as a reference block to inter-code a block in a subsequent video picture. In some examples, such as where the current picture is used as a reference picture to predict the current picture, motion compensation unit 46 and/or summer 62 may update the version of the current picture stored by reference picture memory 64 at regular intervals while coding the current picture. As one example, motion compensation unit 46 and/or summer 62 may update the version of the current picture stored by reference picture memory 64 after coding each block of the current picture. For instance, where the samples of the current block are stored in reference picture memory 64 as initialized values, motion compensation unit 46 and/or summer 62 may update the samples of the current of the current picture stored by reference picture memory 64 with the reconstructed samples for the current block.

A filtering unit (not shown) may perform a variety of filtering processes. For example, the filtering unit may perform deblocking. That is, the filtering unit may receive a plurality of reconstructed video blocks forming a slice or a frame of reconstructed video and filter block boundaries to remove blockiness artifacts from a slice or frame. In one example, the filtering unit evaluates the so-called “boundary strength” of a video block. Based on the boundary strength of a video block, edge pixels of a video block may be filtered with respect to edge pixels of an adjacent video block such that the transition from one video block are more difficult for a viewer to perceive.

In some examples, motion compensation unit 46 and/or summer 62 may update the version of the current picture stored by reference picture memory 64 before the filtering performs the filtering (e.g., deblocking, adaptive loop filtering (ALF) and/or sample adaptive offset (SAO)) to the samples. For instance, the filtering unit may wait until the whole picture is coded before applying the filtering. In this way, motion estimation unit 44 may use the current picture as a reference before applying the filtering. In some examples, the filtering unit may perform the filtering as the version of the current picture stored by reference picture memory 64 is updated. For instance, the filtering unit may apply the filtering as each block is updated. In this way, motion estimation unit 44 may use the current picture as a reference after applying the filtering.

While a number of different aspects and examples of the techniques are described in this disclosure, the various aspects and examples of the techniques may be performed together or separately from one another. In other words, the techniques should not be limited strictly to the various aspects and examples described above, but may be used in combination or performed together and/or separately. In addition, while certain techniques may be ascribed to certain units of video encoder 20 (such as intra prediction unit 48, motion compensation unit 46, or entropy encoding unit 56), it should be understood that one or more other units of video encoder 20 may also be responsible for carrying out such techniques.

In this way, video encoder 20 may be configured to implement one or more example techniques described in this disclosure. For example, video encoder 20 may be configured to code a block of video data in a current picture using a predictor block included in the current picture, i.e., in the same picture. Video encoder 20 may further be configured to output a bitstream that includes a syntax element indicative of whether or not a picture referring to a VPS/SPS/PPS may be present in a reference picture list of the picture itself, e.g., for the purpose of coding one or more blocks of the current picture using Intra BC. That is, when a block is coded using intra BC mode, video encoder 20 may (assuming the syntax element indicates that a current picture can be included in a reference picture list for itself) signal that a reference picture for the block is the picture including the block, e.g., using an index value into a reference picture list such that the index value corresponds to the picture itself. Video encoder 20 may include this index value in motion information of the block that is coded using intra BC mode. In some examples, the hardware architecture of video encoder 20 may or may not be specifically adapted for using a current picture as a reference picture to predict a current block of the current picture.

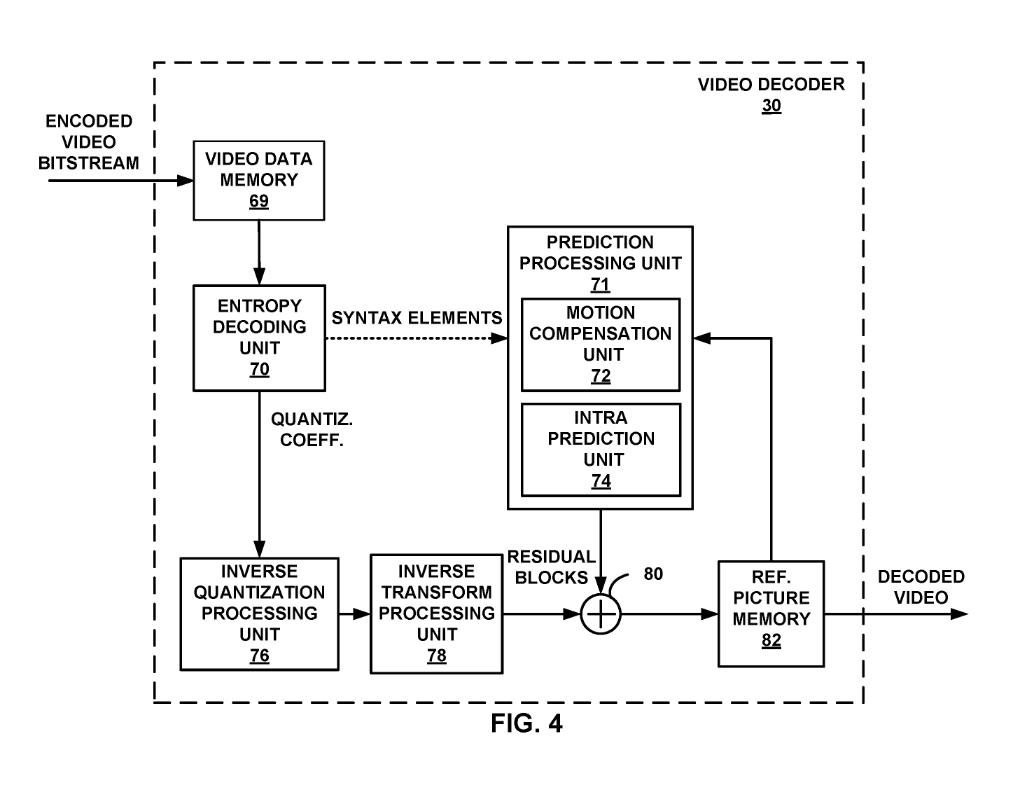

FIG. 4 is a block diagram illustrating an example of video decoder 30 that may implement techniques described in this disclosure. Again, the video decoder 30 will be described in the context of HEVC coding for purposes of illustration, but without limitation of this disclosure as to other coding standards. Moreover, video decoder 30 may be configured to implement techniques in accordance with the range extensions.

In the example of FIG. 4, video decoder 30 may include video data memory 69, entropy decoding unit 70, prediction processing unit 71, inverse quantization processing unit 76, inverse transform processing unit 78, summer 80, and reference picture memory 82. Prediction processing unit 71 includes motion compensation unit 72 and intra prediction unit 74. Video decoder 30 may, in some examples, perform a decoding pass generally reciprocal to the encoding pass described with respect to video encoder 20 from FIG. 3.

Video data memory 69 may store video data, such as an encoded video bitstream, to be decoded by the components of video decoder 30. The video data stored in video data memory 69 may be obtained, for example, from storage device 34, from a local video source, such as a camera, via wired or wireless network communication of video data, or by accessing physical data storage media. Video data memory 69 may form a coded picture buffer (CPB) that stores encoded video data from an encoded video bitstream.

Reference picture memory 82 is one example of a decoded picture buffer (DPB) that stores reference video data for use in decoding video data by video decoder 30 (e.g., in intra- or inter-coding modes). Video data memory 69 and reference picture memory 82 may be formed by any of a variety of memory devices, such as dynamic random access memory (DRAM), including synchronous DRAM (SDRAM), magnetoresistive RAM (MRAM), resistive RAM (RRAIVI), or other types of memory devices. Video data memory 69 and reference picture memory 82 may be provided by the same memory device or separate memory devices. In various examples, video data memory 69 may be on-chip with other components of video decoder 30, or off-chip relative to those components.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

In some examples, when the video slice is coded as an intra-coded (I) slice, intra prediction unit 74 may generate prediction data for a video block of the current video slice based on a signaled intra prediction mode and data from previously decoded blocks of the current picture. In some examples, when the video picture is coded as an inter-coded (i.e., B or P) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists (RPLs). Prediction processing unit 71 may construct the RPLs, e.g., List 0 and List 1, using construction techniques based on reference pictures stored in reference picture memory 82.

In some examples, as opposed to restricting inter-prediction to use other pictures as reference pictures, video decoder 30 may use a current picture as a reference picture to predict blocks of video data included in the current picture. For example, prediction processing unit 71 may store a version of a current picture in prediction processing unit 71. In some examples, prediction processing unit 71 may store an initialized version of the current frame with pixel values initialized to a fixed value. In some examples, the fixed value may be based on a bit depth of samples of the current picture. For instance, the fixed value may be 1<<(bitDepth−1). In some examples, prediction processing unit 71 may store the initialized version of the current picture before encoding any blocks of the current picture. By storing an initialized version of the current picture, prediction processing unit 71 may use predictive blocks that are not yet reconstructed. By contrast, if prediction processing unit 71 does not store an initialized version of the current picture, only blocks that are already reconstructed may be used as predictor blocks (i.e., to avoid a decoder/encoder mismatch).

As discussed above, prediction processing unit 71 may generate one or more RPLs for the current picture. For instance, prediction processing unit 71 may include the current picture an RPL for the current picture.

As discussed above, video decoder 30 may decode a block of video data of a current picture of video data based on a predictive block. In some examples, motion compensation unit 72 may select a block located in the current picture for use as a predictive block for the current block of the current picture. In particular, prediction processing unit 71 may construct, for a current block, an RPL that includes the current picture, motion compensation unit 72 may receive motion parameters for the current block indicating an index in the RPL. In some examples, the index may identify the current picture in the RPL. When this occurs, motion compensation unit 72 may use a motion vector included in the motion parameters to extract a predictor block from the current picture itself at a position identified by the motion vector relative to the current block. In this way, motion compensation unit 72 may perform Intra BC.

Prediction processing unit 71 may determine a motion vector that represents a displacement between the current block of video data and the predictor block of video data. In some examples, prediction processing unit 71 may determine the motion vector based on one or more syntax elements received in the encoded video bitstream. In some examples, prediction processing unit 71 may determine the motion vector with integer precision. In such examples, such as where the current picture is a marked as a long-term reference picture, prediction processing unit 71 may not use normal long-term reference pictures to predict the current picture (i.e., long-term reference pictures that are not the current picture).

Motion compensation unit 72 determines prediction information for a video block of the current video slice by parsing the motion vectors and other syntax elements, and uses the prediction information to produce the predictive blocks for the current block being decoded. For example, motion compensation unit 72 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

As discussed above, video decoder 30 may decode a representation of a motion vector that identifies the position of the predictor block relative to the current block. As one example, entropy decoding unit 70 may decode, and provide to motion compensation unit 72, one or more syntax elements that represent the value of the motion vector. As another example, entropy decoding unit 70 may decode, and provide to motion compensation unit 72, one or more syntax elements that represent a difference between the value of the motion vector and the value of a motion vector predictor, sometimes referred to as the motion vector difference or MVD. In some examples, the motion vector predictor may be a previously coded motion vector, such as the motion vector of a neighboring block. Further details of the use of motion vector predictors are discussed below with reference to FIG. 6.

As discussed above, in some examples, the resolutions used by video decoder 30 for MVD may be adaptive. For instance, motion compensation unit 72 may selectively use either integer-pixel resolution or fractional-pixel resolution to represent the MVD. In some examples, entropy decoding unit 70 may decode, and provide to motion compensation unit 72, a syntax element that indicates whether adaptive motion vector resolution (AMVR) is used. For instance, entropy decoding unit 70 may decode, and provide to motion compensation unit 72, a syntax element (e.g., use_integer_mv_flag) that indicates whether the MVD is represented using integer-pixel resolution or fractional-pixel resolution. Additionally, when the syntax element indicates that AMVR is used, motion compensation unit 72 may scale the motion vector before performing motion compensation (i.e., before identifying the predictor block indicated by the motion vector). For instance, motion compensation unit 72 may scale the motion vector by left shifting the motion vector by two before performing motion compensation

As discussed above, in some examples, the resolution of the MVD and the location of the predictor block identified by the motion vector may dictate the resolution at which motion compensation unit 72 stores the motion vector. However, in some examples, storing motion vectors with different resolutions may introduce undesirable complexity to video decoder 30.

In accordance with one or more techniques of this disclosure, as opposed to storing motion vectors at different resolutions based on the location of the predictor block and whether AMVR is used, video decoder 30 may store the value of a motion vector that identifies a predictor block for a current block in a current picture at a particular resolution regardless of whether AMVR is used for the current block and regardless of whether the predictor block is included in the current picture. For instance, motion compensation unit 72 may always store motion vectors with quarter-pixel resolution. By storing motion vectors that indicate predictor blocks in different pictures using the same resolution as motion vectors that indicate predictor blocks in the current picture, the techniques of this disclosure may enable motion compensation unit 72 to use previous motion vectors that identify predictor blocks in either the current picture or a different picture as motion vector predictors for motion vectors that identify predictor blocks in either the current picture or a different picture without performing different processes when AMVR is used. Additionally, by always storing motion vectors with the same resolution, motion compensation unit 72 may avoid having to scale motion vectors prior to performing motion compensation. In this way, the techniques of this disclosure may reduce the complexity of using predictor blocks in the current picture.

Inverse quantization processing unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied.

Inverse transform processing unit 78 applies an inverse transform, e.g., an inverse DCT, an inverse integer transform, or a conceptually similar inverse transform process, to the transform coefficients in order to produce residual blocks in the pixel domain. Video decoder 30 forms a decoded video block by summing the residual blocks from inverse transform processing unit 78 with the corresponding predictive blocks generated by motion compensation unit 72. Summer 80 represents the component or components that perform this summation operation.

Video decoder 30 may include a filtering unit, which may, in some examples, be configured similarly to the filtering unit of video encoder 20 described above. For example, the filtering unit may be configured to perform deblocking, SAO, or other filtering operations when decoding and reconstructing video data from an encoded bitstream.

While a number of different aspects and examples of the techniques are described in this disclosure, the various aspects and examples of the techniques may be performed together or separately from one another. In other words, the techniques should not be limited strictly to the various aspects and examples described above, but may be used in combination or performed together and/or separately. In addition, while certain techniques may be ascribed to certain units of video decoder 30 it should be understood that one or more other units of video decoder 30 may also be responsible for carrying out such techniques.

In this way, video decoder 30 may be configured to implement one or more example techniques described in this disclosure. For example, video decoder 30 may be configured to receive a bitstream that includes a syntax element indicative of whether or not a picture referring to a PPS may be present in a reference picture list of the picture itself, e.g., for the purpose of coding one or more blocks of the current picture using intra BC mode. That is, video decoder 30 may decode a value for the syntax element that indicates that a current picture can be included in a reference picture list for itself. Accordingly, when a block is coded using intra BC mode, video decoder 30 may determine that a reference picture for the block is the picture including the block, e.g., using an index value into a reference picture list such that the index value corresponds to the picture itself. Video decoder 30 may decode this index value from motion information of the block that is coded using intra BC mode. In some examples, the hardware architecture of video decoder 30 may not be specifically adapted for using a current picture as a reference picture to predict a current block of the current picture.

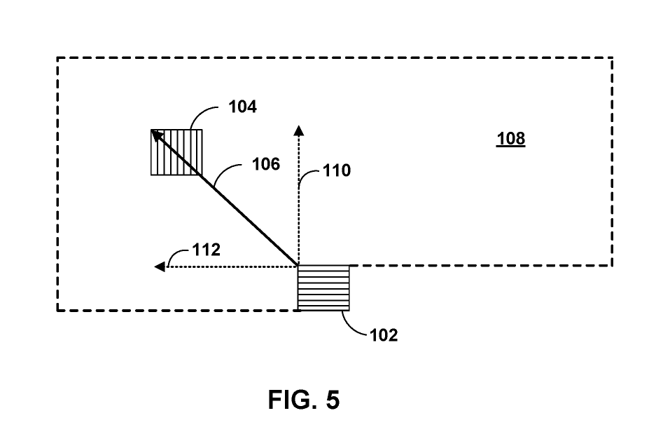

FIG. 5 is a diagram illustrating an example of an Intra BC process, in accordance with one or more techniques of this disclosure. According to one example intra-prediction process, video encoder 20 may select, for a current block to be coded in a picture, a predictor video block, e.g., from a set of previously coded and reconstructed blocks of video data, in the same picture. In the example of FIG. 5, reconstructed region 108 includes the set of previously coded and reconstructed video blocks. The blocks in the reconstructed region 108 may represent blocks that have been decoded and reconstructed by video decoder 30 and stored in reconstructed region memory 92, or blocks that have been decoded and reconstructed in the reconstruction loop of video encoder 20 and stored in reconstructed region memory 64. Current block 102 represents a current block of video data to be coded. Predictor block 104 represents a reconstructed video block, in the same picture as current block 102, which is used for Intra BC prediction of current block 102.

In the example intra-prediction process, video encoder 20 may select predictor block 104 from within a search region. As discussed above and in accordance with one or more techniques of this disclosure, video encoder 20 may determine the search region based on a resolution to be used for a motion vector that indicates predictor block 104 (i.e., a resolution that will be used for motion vector 106). In the example of FIG. 5, based on determining that integer-pixel resolution will be used for motion vector 106, video encoder 20 may determine that the search region consists of reconstructed region 108 and select predictor block 104 from within reconstructed region 108. Video encoder 20 may then determine and encode motion vector 106, which indicates the position of predictor block 104 relative to current block 102, together with the residue signal. For instance, as illustrated by FIG. 5, motion vector 106 may indicate the position of the upper-left corner of predictor block 104 relative to the upper-left corner of current block 102. As discussed above, motion vector 106 may also be referred to as an offset vector, displacement vector, or block vector (BV). Video decoder 30 may utilize the encoded information for decoding the current block.

In accordance with one or more techniques of this disclosure, as opposed to storing motion vector 106 at a resolution based on the location of predictor block 104 and whether AMVR is used, video encoder 20 may store the value of motion vector 106 (i.e., the value of vertical component 110 and the value of horizontal component 112) at a particular resolution regardless of whether AMVR is used for current block 012 and regardless of whether the predictor block is included in the current picture. In this way, video encoder 20 may reduce the complexity of using predictor blocks in the current

Video decoder 30 may decode, based on the RPL, a block of video data in the current picture. In particular, video decoder 30 may decode a block of video data based on a predictor block included in the version of the current picture stored in reference picture memory 82. In other words, when decoding a block of the current picture, video decoder 30 may predict the block from the current picture, namely the reference with reference index IdxCur (in ListX). Video decoder 30 may write the reconstructed samples of the block to the current picture buffer (e.g., reference picture memory 82) to replace the initialized values (e.g., after the video decoder has finished decoding the block). Note that in this example, video decoder 30 does not apply deblocking, SAO or any other filtering operation to the reconstructed samples after decoding the block. In other words, video decoder 30 may use the current picture as a reference before applying deblocking and SAO. After coding the whole picture, video decoder 30 may apply deblocking, SAO and other operations such as reference picture marking in the same way as those described in HEVC version 1.

In accordance with one or more techniques of this disclosure, as opposed to storing motion vector 106 at a resolution based on the location of predictor block 104 and whether AMVR is used, video decoder 30 may store the value of motion vector 106 (i.e., the value of vertical component 110 and the value of horizontal component 112) at a particular resolution regardless of whether AMVR is used for current block 012 and regardless of whether the predictor block is included in the current picture. In this way, video decoder 30 may reduce the complexity of using predictor blocks in the current picture.

FIG. 6 is a diagram illustrating an example of process for using motion vector predictors, in accordance with one or more techniques of this disclosure. In some implementations of the HEVC standard, there may be two inter prediction modes, named merge mode (skip is considered as a special case of merge) and advanced motion vector prediction (AMVP) mode, which may be used to predict a prediction unit (PU).

In either AMVP or merge mode, video encoder 20 and/or video encoder 30 may maintain a motion vector candidate list for multiple motion vector predictors. Video encoder 20 and/or video encoder 30 may generate the motion vector(s), as well as reference indices in the merge mode, of the current PU by taking one candidate from the motion vector candidate list.

The motion vector candidate list may contain up to a first threshold number of candidates (e.g., 2, 5, 10) for the merge mode and a second threshold number of candidates for the AMVP mode (e.g., 2, 3). A merge candidate may contain a set of motion information, e.g., motion vectors corresponding to both reference picture lists (list 0 and list 1) and the reference indices. If a merge candidate is identified by a merge index, the reference pictures may be used for the prediction of the current blocks, as well as the associated motion vectors are determined. However, under AMVP mode for each potential prediction direction from either list 0 or list 1, a reference index may be explicitly signaled, together with an MVP index to the motion vector candidate list (i.e., as the AMVP candidate may contain only a single motion vector). In AMVP mode, the predicted motion vectors can be further refined.

A merge candidate may correspond to a full set of motion information while an AMVP candidate may contain just one motion vector for a specific prediction direction and reference index. Video encoder 20 and/or video encoder 30 may similarly derive the candidates for both modes from the same spatial and temporal neighboring blocks.

Video encoder 20 and/or video encoder 30 may derive spatial motion vector candidates from the neighboring blocks shown in the example of FIG. 6, for a specific PU (PU₀ 602), although the methods generating the candidates from the blocks may differ for merge and AMVP modes.

In merge mode, example positions of five spatial motion vector candidates are shown in FIG. 6. The availability of the spatial motion vector candidates at each candidate position may checked according to a particular order (e.g., a₁ 604B, b₁ 606B, b₀ 606A, a₀ 604A, b₂ 606C).

In AMVP mode, the neighboring blocks may be divided into two groups. For instance, the neighboring blocks may be divided into a left group which may include the blocks a₀ 604A and a₁ 604B, and an above group which may include the blocks b₀ 606A, b₁ 606B, and b₂ 606C as shown in FIG. 6. For the left group, the availability may be checked according to the order: {a₀ 604A, a₁ 604B}. For the above group, the availability may be checked according to the order: {b₀ 606A, b₁ 606B, b₂ 606C}. For each group, the potential candidate in a neighboring block referring to the same reference picture as that indicated by the signaled reference index may have the highest priority to be chosen to form a final candidate of the group. It is possible that all neighboring blocks do not contain a MV pointing to the same reference picture. Therefore, if such a candidate cannot be found, video encoder 20 and/or video encoder 30 may scale the first available candidate to form the final candidate, thus the temporal distance differences can be compensated.

In some examples, video encoder 20 and/or video encoder 30 may consider other candidates besides the spatial neighboring candidates. For instance, in merge mode, after validating the spatial candidates, two kinds of redundancies may be removed. As one example, if the candidate position for the current PU would refer to the first PU within the same CU, the position may be excluded (i.e., removed from consideration), as the same merge could be achieved by a CU without splitting into prediction partitions. As another example, any redundant entries where candidates have exactly the same motion information may also excluded. After the spatial neighboring candidates are checked, the temporal candidates may be validated. For the temporal candidate, the right bottom position just outside of the collocated PU of the reference picture may be used if it is available. Otherwise, the center position may be used instead.

The way to choose the collocated PU may similar to that of prior standards, but HEVC allows more flexibility by transmitting an index to specify which reference picture list is used for the collocated reference picture. One issue related to the use of the temporal candidate is the amount of the memory to store the motion information of the reference picture. This may be addressed by restricting the granularity for storing the temporal motion candidates to only the resolution of a 16×16 luma grid, even when smaller PU structures are used at the corresponding location in the reference picture. In addition, a PPS-level flag may allow the encoder to disable the use of the temporal candidate, which may be useful for applications with error-prone transmission.

The maximum number of merge candidates C may be specified in the slice header. If the number of merge candidates found (including the temporal candidate) is larger than C, only the first C−1 spatial candidates and the temporal candidate may be retained. Otherwise, if the number of merge candidates identified is less than C, additional candidates may be generated until the number is equal to C. This may simplify the parsing and may make the parsing more robust, as the ability to parse the coded data is not dependent on merge candidate availability.

For B slices, additional merge candidates may be generated by choosing two existing candidates according to a predefined order for reference picture list 0 and list 1. For example, the first generated candidate may use the first merge candidate for list 0 and the second merge candidate for list 1. Some examples of the HEVC standard specify a total of 12 predefined pairs of two in the following order in the already constructed merge candidate list as (0, 1), (1, 0), (0, 2), (2, 0), (1, 2), (2, 1), (0, 3), (3, 0), (1, 3), (3, 1), (2, 3), and (3, 2). Among them, up to five candidates can be included after removing redundant entries. When the number of merge candidates is still less than C, default merge candidates, including default motion vectors and the corresponding reference indices, may be used instead with zero motion vectors associated with reference indices from zero to the number of reference pictures minus one are used to fill any remaining entries in the merge candidate list.

In AMVP mode, some examples of the HEVC standard allow a much lower number of candidates to be used in the motion vector prediction process case, since the encoder can send a coded difference to change the motion vector. Furthermore, the encoder needs to perform motion estimation, which may be one of the most computationally expensive operations in the encoder, and complexity may be reduced by allowing a small number of candidates. When the reference index of the neighboring PU is not equal to that of the current PU, a scaled version of the motion vector may be used. The neighboring motion vector may be scaled according to the temporal distances between the current picture and the reference pictures indicated by the reference indices of the neighboring PU and the current PU, respectively. When two spatial candidates have the same motion vector components, one redundant spatial candidate may be excluded. When the number of motion vector predictors is not equal to two and the use of temporal motion vector prediction is not explicitly disabled, the temporal motion vector prediction candidate may be included. This means that the temporal candidate may not be used at all when two spatial candidates are available. Finally, the default motion vector (which may be zero motion vector) may be included repeatedly until the number of motion vector prediction candidates is equal to two, which may ensure that the number of motion vector predictors is two. Thus, in the case of AMVP mode, only a coded flag may be necessary to identify which motion vector prediction is used.

As discussed above and in accordance with one or more techniques of this disclosure, as opposed to storing motion vectors at different resolutions based on the location of the predictor block and whether AMVR is used, video encoder 20 and/or video decoder 30 may store the value of a motion vector that identifies a predictor block for a current block in a current picture at a particular resolution regardless of whether AMVR is used for the current block and regardless of whether the predictor block is included in the current picture. For instance, video encoder 20 and/or video decoder 30 may always store motion vectors with quarter-pixel resolution. By storing motion vectors that indicate predictor blocks in different pictures using the same resolution as motion vectors that indicate predictor blocks in the current picture, the techniques of this disclosure may enable video encoder 20 and/or video decoder 30 to use previous motion vectors that identify predictor blocks in either the current picture or a different picture as motion vector predictors for motion vectors that identify predictor blocks in either the current picture or a different picture without performing different processes when AMVR is used. Additionally, by always storing motion vectors with the same resolution, video encoder 20 and/or video decoder 30 may avoid having to scale motion vectors prior to performing motion compensation. In this way, the techniques of this disclosure may reduce the complexity of using predictor blocks in the current picture.

This disclosure proposes various schemes of storage of motion vectors for Intra BC and inter modes, including their interactions with adaptive motion vector resolution and Intra BC/inter unification. Each of the techniques proposed below may apply separately, independently or jointly in combination with one or more of the other techniques discussed herein. As used in the below discussion, an Intra BC MV may be a motion vector for a current block that identifies a predictor block in the same picture as the current block, and an Inter MV may be a motion vector for a current block that identifies a predictor block in a different picture than the current block.

In some examples, the resolution at which video encoder 20 and/or video encoder 30 may store Intra BC MV and Inter MV may be dependent on the value of the flag use_integer_mv_flag, which indicates the usage of AMVR, for example in the current slice. In some examples, the resolution of both stored Intra BC MV and Inter MV may always be in fractional-pixel value (independent to value of use_integer_mv_flag). In some examples, the resolution at which video encoder 20 and/or video encoder 30 may store Intra BC MV and Inter MV may always be integer-pixel value when AMVR is enabled. (use_integer_mv_flag=1). In some examples, the resolution at which video encoder 20 and/or video encoder 30 may store Intra BC MV and Inter MV may always be integer-pixel value when AMVR is enabled (use_integer_mv_flag=1) and always be fractional-pixel value when AMVR is not enabled. (use_integer_mv_flag=0). In some examples, the resolution at which video encoder 20 and/or video encoder 30 may store Intra BC MV may always be integer-pixel value. In some examples, the resolution at which video encoder 20 and/or video encoder 30 may store Intra BC MV may always be integer-pixel value and the resolution at which video encoder 20 and/or video encoder 30 may store inter MV may always be in fractional-pixel. In some examples, the resolution at which video encoder 20 and/or video encoder 30 may store Intra BC MV may always be integer-pixel value and the resolution at which video encoder 20 and/or video encoder 30 may store Inter MV may be in integer-pixel when AMVR is enabled (use_integer_mv_flag=1) and the resolution at which video encoder 20 and/or video encoder 30 may store Inter MV may be in fractional-pixel when AMVR is not enabled (use_integer_mv_flag=0).

In accordance with one or more techniques of this disclosure, the resolution at which video encoder 20 and/or video decoder 30 stores spatial motion vector candidates in merge and AMVP modes can be different from the resolution at which video encoder 20 and/or video decoder 30 stores motion vectors for TMVP. The following techniques can be applied for Intra BC, Inter mode, or both modes. Additionally, the techniques can be applied selectively based on AMVR enabled flag, for example they applied only when AMVR flag is enabled (integer_mv_flag=1). For example, spatial motion vector accuracy can be kept as in SCC WD 3, but when storing motion vectors for the TMVP, video encoder 20 and/or video decoder 30 may use consistent motion vector accuracy across Intra BC and Inter mode. For instance, video encoder 20 and/or video decoder 30 may store all motion vectors with the same accuracy, integer-pixel or fractional-pixel. If needed, video encoder 20 and/or video decoder 30 may perform rounding, downscaling (for example, right shift by 2) or upscaling (for example, left shift by 2) to equalize motion vector accuracy.

This disclosure proposes various schemes of signalling of motion vector difference (MVD) for Intra BC/inter modes, including their interactions with AMVR and Intra BC/inter unification. Each of techniques proposed below may apply separately, independently or jointly in combination with one or more of the other techniques discussed herein. As used in the below discussion, an Intra BC MVD may the difference between the value of a motion vector predictor and the value of a motion vector for a current block that identifies a predictor block in the same picture as the current block, and an Inter MVD may the difference between the value of a motion vector predictor and the value of a motion vector for a current block that identifies a predictor block in a different picture than the current block.

In some examples, video encoder 20 and/or video decoder 30 may always code both Intra BC MVD and Inter MVD with fractional-pixel resolution when AMVR is not enabled (use_integer_mv_flag=0). In some examples, video encoder 20 and/or video decoder 30 may code both Intra BC MVD and Inter MVD with integer-pixel resolution when AMVR is enabled (use_integer_mv_flag=1) and may code both Intra BC MVD and Inter MVD in fractional-pixel (e.g., quarter-pixel) when AMVR is not enabled (use_integer_mv_flag=0).

This disclosure proposes various schemes of motion vector derivation for Intra BC and inter modes, including their interactions with adaptive motion vector resolution and Intra BC/inter unification. Each of techniques proposed below may apply separately, independently or jointly in combination with one or more of the other techniques discussed herein. In general, the motion vector (MV) derivation can be described based on the desired resolution as MV=((MVP>>m1))+MVD)<<m1, where m1=0, 1, 2 . . . . In the case of merge and Skip mode, MVD may not signaled and MV can be expressed as MV=(MVP>>m2)<<m2, where m2=0, 1, 2 . . . .

In some examples, video encoder 20 and/or video decoder 30 may base the value of ‘m1’ and ‘m2’ in the above expression on the value of integer_mv_flag. In some examples, video encoder 20 and/or video decoder 30 may always use zero as the value of ‘m1’ and ‘m2’ in the above expression. In some examples, both Intra BC MV and Inter MV derivation may have the value of m1, m2=2 when AMVR is enabled (use_integer_mv_flag=1). In some examples, both Intra BC MV and Inter MV derivation may have the value of m1, m2=2 when AMVR is enabled (use_integer_mv_flag=1) and both Intra BC MV and Inter MV derivation may have the value of m1, m2=0 when AMVR is not enabled (use_integer_mv_flag=0). In some examples, Intra BC MV derivation may have the value of m1, m2=2 always. Inter MV derivation may have the value of m1, m2=0 when AMVR is not enabled (use_integer_mv_flag=0) and have the value of m1, m2=2 when AMVR is enabled (use_integer_mv_flag=1). In some examples, both Intra BC MV and Inter MV derivation may have the value of m1, m2=2 when AMVR is enabled (use_integer_mv_flag=1) and Intra BC MV derivation may have the value of m1, m2=2 when AMVR is not enabled (use_integer_mv_flag=0) and Inter MV derivation may have the value of m1, m2=0 when AMVR is not enabled (use_integer_mv_flag=0).

This disclosure proposes various schemes of motion vector scaling for Intra BC/inter modes, including their interactions with AMVR and Intra BC/inter unification. Each of techniques proposed below may apply separately, independently or jointly in combination with one or more of the other techniques discussed herein. In some proposals for the SCC specification (e.g., SCC Draft 3), motion vectors of inter are scaled (left shifted by 2) before the motion compensation process when AMVR is enabled (use_integer_mv_flag=1). It should be noted that this motion vector scaling is different from temporal motion vector/merge motion vector scaling.

In some examples, video encoder 20 and/or video decoder 30 may scale the motion vector (as described above) for Intra BC and inter based on the value of integer_mv_flag. In some examples, video encoder 20 and/or video decoder 30 may scale the MV (as described above) for Intra BC and inter when AMVR is enabled (use_integer_mv_flag=1). In some examples, video encoder 20 and/or video decoder 30 may scale the MV (as described above) for Intra BC and inter when AMVR is enabled (use_integer_mv_flag=1) and video encoder 20 and/or video decoder 30 may scale the MV only for Intra BC when AMVR is not enabled (use_integer_mv_flag=0) and not scaled for Inter.

In merge or AMVP mode, for both Inter mode and Intra BC, some motion vector candidates may require temporal scaling, those candidates, for example, can be TMVP or spatial candidates in AMVP mode. This temporal scaling can make the motion vector candidate to be non-integer.

In some proposals for SCC (e.g., SCC WD 3), such candidates or predictors are not allowed to be used and signaled in merge mode with Intra BC mode, and are left shifted by 2 if AMVR is enabled. The common problem of both modes is that those candidates are very likely to have an incorrect motion vector resolution and may not efficient for prediction.

This disclosure proposes several solutions to overcome such a problem, which can be used separately or in any combination with other proposed techniques discussed herein, and can be applied for merge mode, AMVP mode, or both and for Intra BC mode, Inter mode, or both.

In some examples, video encoder 20 and/or video decoder 30 may mark an MV candidate as unavailable if it requires temporal MV scaling or the candidate is not integer-pixel MV. Additionally, in some example, marking the candidate as unavailable may be dependent on AMVR enable flag. For example, video encoder 20 and/or video decoder 30 may mark the candidate as unavailable, when AMVR is enabled (use_integer_mv_flag=1). In some examples, video encoder 20 and/or video decoder 30 may round a MV candidate or predictor that requires scaling to the integer-pixel MV after scaling. For example, a MV is derived as MV=(MVP>>2)<<2. Video encoder 20 and/or video decoder 30 may apply the same technique to all MV candidates or MV predictors which are not integer-pixel MVs, and in this case, the constraint that MVP shall have integer accuracy with Intra BC and merge mode can be removed. In another example, video encoder 20 and/or video decoder 30 may round a MV candidate towards closest integer-pixel MV. Additionally, rounding the candidate which requires temporal MV scaling may be dependent on AMVR enable flag. For example, the candidate may be rounded if AMVR is enabled (use_integer_mv_flag=1).

There is one special case for AMVP, when mvd_11_zero_flag is enabled and bi-prediction is used. In this case, video encoder 20 and/or video decoder 30 may not signal the MVD for the MV coming from reference picture list 1 (RefPicList1) and MVD may be inferred equal to 0. In this case, such MV candidate in AMVP is similar to merge candidate, where MVD is not signalled, and this candidate may be rounded to be integer if Intra BC mode is used in SCC WD 3.

In accordance with one or more techniques of this disclosure, when mvd_11_zero_flag is enabled and bi-prediction is applied, video encoder 20 and/or video decoder 30 may treat such an AMVP candidate in the same way as it is done for merge candidate for Intra BC mode, Inter mode, or both. For example, video encoder 20 and/or video decoder 30 may not round an AMVP candidate when mvd_11_zero_flag is equal to 1 with bi-prediction to preserve higher MV accuracy. Additionally, the MV rounding can be dependent on AMVR enable flag. For example, when AMVR is enabled (e.g., use_integer_mv_flag=1), video encoder 20 and/or video decoder 30 may round the candidate.

In SCC WD 3, bi-prediction is disabled to reduce bandwidth, i.e., inter direction flag signalling is modified to indicate only uni-directional prediction and bi-directional merge candidate is converted to uni-L0 MV candidates, for 4×8 and 8×4 PUs. However, when AMVR is enabled (e.g., use_integer_mv_flag=1) for inter mode or Intra BC is used, the MV used for prediction has integer accuracy and there is no interpolation, so bandwidth may not be increased since extra pixels to be fetched for interpolation are not needed.

In some examples, when AMVR is enabled for inter mode or Intra BC is used, bi-prediction, which is disabled for the certain block sizes that require interpolation, can be allowed when MV is integer, for example when AMVR or Intra BC modes are in use, or both modes. In some examples, when AMVR is enabled for inter mode or Intra BC is used, for example, AMVR flag (for example, AMVR slice flag) and/or Intra BC mode (for example, checking the POC of the reference picture whether it is equal to the current picture POC, or Intra BC mode flag) check is included to allow inter direction signalling to indicate bi-prediction and the similar check is included to disable conversion of bi-directional candidate to uni-L0 MV candidate in the merge mode for restricted block sizes, for example 8×4 and 4×8 PUs. These techniques can be used independently or in any combination with other described techniques.

Various example implementations are proposed based on the techniques described above. Each of the examples combines one or more aspects from the techniques described above. In all examples below, the following can be optionally applied separately or in any combination for Intra BC, Inter mode, or both modes. Additionally, the following can be applied depending on AMVR enable flag, for example the methods are applied when use_integer_mv_flag is equal to 1:
a. If merge mode is used, MV may rounded and is derived as MV=(MVP>>2)<<2. In this case, the constraint that MVP shall have integer accuracy with Intra BC and merge mode can be removed.
b. If AMVP mode is used and mvd_11_aero_flag is 1, MV may not be rounded and may be derived as MV=MVP for RefPicList1 and bi-prediction.

### Example 1

When use_integer_mv_flag is 0,
a. Both Intra BC MVD and Inter MVD may be coded with fractional-pixel resolution.
b. The stored Intra BC MV may be derived as MV=((MVP>>2)+MVD)<<2, and
c. The stored Inter MV may be derived as MV=MVP+MVD.
   When use_integer_mv_flag is 1,
a. Both Intra BC MVD and Inter MVD may be coded with integer-pixel resolution.
b. The stored Intra BC MV may be derived as MV=((MVP>>2)+MVD)<<2, and
c. The stored Inter MV may be derived as MV=MVP+MVD.
d. The Inter MV may be scaled by 2, (that is MV=MV<<2) for the motion compensation process.

Where MVP is the corresponding MV predictor. Other conversion mechanism or rounding might be applicable. For merge, the MVD may be zero and MVP may be the MV from the corresponding merge candidate.

### Example 2

When use_integer_mv_flag is 0,
a. Intra BC MVD may be coded with integer-pixel resolution and Inter MVD may be coded with fractional-pixel resolution.
b. The stored Intra BC MV may be derived as MV=((MVP>>2)+MVD)<<2, and
c. The stored Inter MV may be derived as MV=MVP+MVD.
   When use_integer_mv_flag is 1,
a. Both Intra BC MVD and Inter MVD may be coded with integer-pixel resolution.
b. The stored Intra BC MV and Inter MV may be derived as MV=((MVP>>2)+MVD)<<2

Where MVP is the corresponding MV predictor. Other conversion mechanism or rounding might be applicable. For merge, the MVD may be zero and MVP may be the MV from the corresponding merge candidate.

### Example 3

When use_integer_mv_flag is 0,
a. Intra BC MVD may be coded with integer-pixel resolution and Inter MVD may be coded with fractional-pixel resolution.
b. The stored Intra BC and Inter MV may be derived as MV=MVP+MVD.
   When use_integer_mv_flag is 1,
a. Both Intra BC MVD and Inter MVD may be coded with integer-pixel resolution.
b. The stored Intra BC MV and Inter MV may be derived as MV=((MVP>>2)+MVD)<<2

Where MVP is the corresponding MV predictor. Other conversion mechanism or rounding might be applicable. For merge, the MVD may be zero and MVP may be the MV from the corresponding merge candidate.

### Example 4

When use_integer_mv_flag is 0,
a. Intra BC MVD may be coded with integer-pixel resolution and Inter MVD may be coded with fractional-pixel resolution.
b. The stored Intra BC MV may be derived as MV=((MVP>>2)+MVD)<<2, and
c. The stored Inter MV may be derived as MV=MVP+MVD.
   When use_integer_mv_flag is 1,
a. Both Intra BC MVD and Inter MVD may be coded with integer-pixel resolution.
b. The stored Intra BC MV and Inter MV may be derived as MV=MVP+MVD.
c. The Intra BC and Inter MV may be scaled by 2, (that is MV=MV<<2) for the motion compensation process.

Where MVP is the corresponding MV predictor. Other conversion mechanism or rounding might be applicable. For merge, the MVD may be zero and MVP may be the MV from the corresponding merge candidate.

### Example 5

When use_integer_mv_flag is 0,
a. Intra BC MVD may be coded with integer-pixel resolution and Inter MVD may be coded with fractional-pixel resolution.
b. The stored Intra BC MV and Inter MV may be derived as MV=MVP+MVD.
c. The Intra BC MV may be scaled by 2, (that is MV=MV<<2) for the motion compensation process
   When use_integer_mv_flag is 1,
a. Both Intra BC MVD and Inter MVD may be coded with integer-pixel resolution.
b. The stored Intra BC MV and Inter MV may be derived as MV=MVP+MVD.
c. The Intra BC and Inter MV may be scaled by 2, (that is MV=MV<<2) for the motion compensation process.

Where MVP is the corresponding MV predictor. Other conversion mechanism or rounding might be applicable. For merge, the MVD may be zero and MVP may be the MV from the corresponding merge candidate.

### Example 6

When use_integer_mv_flag is 0,
a. Intra BC MVD and Inter MVD may be coded with fractional-pixel resolution.
b. The stored Intra BC MV and Inter MV may be derived as MV=MVP+MVD.
   When use_integer_mv_flag is 1,
a. Both Intra BC MVD and Inter MVD may be coded with integer-pixel resolution.
b. The stored Intra BC MV and Inter MV may be derived as MV=MVP+MVD.
c. The Intra BC and Inter MV may be scaled by 2, (that is MV=MV<<2) for the motion compensation process.

Where MVP is the corresponding MV predictor. Other conversion mechanism or rounding might be applicable. For merge, the MVD may be zero and MVP may be the MV from the corresponding merge candidate.

### Example 7

When use_integer_mv_flag is 0,
a. Intra BC MVD may be coded with integer-pixel resolution and Inter MVD may be coded with fractional-pixel resolution.
b. The stored Intra BC MV and Inter MV may be derived as MV=MVP+MVD.
   When use_integer_mv_flag is 1,
a. Both Intra BC MVD and Inter MVD may be coded with integer-pixel resolution.
b. The stored Intra BC MV and Inter MV may be derived as MV=MVP+MVD.
c. The Intra BC and Inter MV may be scaled by 2, (that is MV=MV<<2) for the motion compensation process.

Where MVP is the corresponding MV predictor. Other conversion mechanism or rounding might be applicable. For merge, the MVD may be zero and MVP may be the MV from the corresponding merge candidate.

### Example 8

When use_integer_mv_flag is 0,
a. Intra BC MVD may be coded with integer-pixel resolution and Inter MVD may be coded with fractional-pixel resolution.
b. The stored Intra BC MV and Inter MV may be derived as MV=MVP+MVD.
c. The Intra BC MV may be scaled by 2, (that is MV=MV<<2) for the motion compensation process
   When use_integer_mv_flag is 1,
a. Both Intra BC MVD and Inter MVD may be coded with integer-pixel resolution.
b. The stored Intra BC MV and Inter MV may be derived as MV=MVP+MVD.
c. The Intra BC and Inter MV may be scaled by 2, (that is MV=MV<<2) for the motion compensation process.

Where MVP is the corresponding MV predictor. Other conversion mechanism or rounding might be applicable. For merge, the MVD may be zero and MVP may be the MV from the corresponding merge candidate.

Tables 2-3, below, summarize some of the examples described above. The text in italics indicates the differences with respect to the current specification, which is summarized below in Table 1. Each of Tables 1-3 provides two cases, determined based on a value of a syntax element. Where the syntax element has a first value (e.g., 0) the first case would apply. Similarly, where the syntax element has a second value (e.g., 1) the second case would apply. In some examples, the syntax element may be the Adaptive MV Resolution (AVMR) syntax element. As such, in some examples, this disclosure proposes modifying the effects of the AVMR syntax element.

Each cell in Tables 1-3 provides a mapping between a value of the syntax element and a calculation method for a motion vector (MV) or a block vector (BV) based on a vector predictor (P), a resolution at which the MV or BV is to be stored, whether the MV or BV is scaled to perform motion compensation, and a resolution at which a motion vector difference (MVD) or a block vector difference (BVD) is coded. If the current block is coded using Intra BC, the BV/BVD values would apply. Similarly, if the current block is coded using intra mode, the MV/MVD values would apply.

In operation a video decoder may determine the calculation method, the storage resolution, whether the vector is shifted to perform motion compensation, and the vector difference resolution for the current block based on the value of the syntax element.

TABLE 1

| | SCM Method |
|---|---|
| | Storage not aligned |
| | BV calc aligned |
| | MV calc aligned |
| 1^{st} Value | BV = (P >> 2 + BVD) << 2 |
| (e.g., 0) | MV = (P + MVD) |
| | Storage: BV = Q, MV = Q |
| | Shift for MC: None for BV |
| | None for MV |
| | BVD: Integer-pel |
| | MVD: Quarter-pel |
| 2^{nd} Value | BV = (P >> 2 + BVD) << 2 |
| (e.g., 1) | MV = (P + MVD) |
| | Storage: BV = Q, MV = Int |
| | Shift for MC: None for BV |
| | <<2 for MV |
| | BVD: Integer-pel |
| | MVD: Integer-pel |

TABLE 2

| | BVD Alignment | Storage Alignments | | |
|---|---|---|---|---|
| | 1. Aligned across AMVR | 2. Aligned across AMVR | 3. Aligned across AMVR mode | 4. Aligned within a AMVR |
| | mode | mode | IBC is Q-pel | mode |
| 1^{st} Value | BV = (P + BVD) | BV = (P >> 2 + BVD) << 2 | BV = (P + BVD) | BV = (P >> 2 + BVD) << 2 |
| (e.g., 0) | MV = (P + MVD) | MV = (P + MVD) | (interpolation) | MV = (P + MVD) |
| | Storage: BV = Q, MV = Q | Storage: BV = Q, MV = Q | MV = (P + MVD) | Storage: BV = Q, MV = Q |
| | Shift for MC: None for BV | Shift for MC: None for BV | Storage: BV = Q, MV = Q | Shift for MC: None for BV |
| | None for MV | None for MV | Shift for MC: None for BV | None for MV |
| | BVD: Quarter-pel | BVD: Integer-pel | None for MV | BVD: Integer-pel |
| | MVD: Quarter-pel | MVD: Quarter-pel | BVD: Integer-pel | MVD: Quarter-pel |
| | | | MVD: Quarter-pel | |
| 2^{nd} Value | BV = (P >> 2 + BVD) << 2 | For AMVR = 1, | BV = (P >> 2 + BVD) << 2 | BV = (P + BVD) |
| (e.g., 1) | MV = (P + MVD) | BV = (P >> 2 + BVD) << 2 | MV = (P >> 2 + MVD) << 2 | MV = (P + MVD) |
| | Storage: BV = Q, MV = Int | MV = (P >> 2 + MVD) << 2 | Storage: BV = Q, MV = Q | Storage: BV = Int, MV = Int |
| | Shift for MC: None for BV | Storage: BV = Q, MV = Q | Shift for MC: None for BV | Shift for MC: <<2 for BV |
| | <<2 for MV | Shift for MC: None for BV | None for MV | <<2 for MV |
| | BVD: Integer-pel | None for MV | BVD: Integer-pel | BVD: Integer-pel |
| | MVD: Integer-pel | BVD: Integer-pel | MVD: Integer-pel | MVD: Integer-pel |
| | | MVD: Integer-pel | | |

TABLE 3

| | BV and MV Calc Alignments | | | |
|---|---|---|---|---|
| | 5. Aligned for IBC mode and | | 7. MV derivation aligned | 8. Aligned across AMVR |
| | non-IBC mode | 6. Aligned within a AMVR | across AMVR modes | mode |
| | BV calc same for IBC mode | mode | IBC is Q-pel | IBC is Q-pel |
| 1^{st} Value | BV = (P + BVD) | BV = (P + BVD) | BV = (P + BVD) | BV = (P + BVD) |
| (e.g., 0) | MV = (P + MVD) | MV = (P + MVD) | (interpolation) | MV = (P + MVD) |
| | Storage: BV = Int, MV = Q | Storage: BV = Q, MV = Q | MV = (P + MVD) | Storage: BV = Int, MV = Q |
| | Shift for MC: <<2 for BV | Shift for MC: None for BV | Storage: BV = Q, MV = Q | Shift for MC: <<2 for BV |
| | None for MV | None for MV | Shift for MC: None for BV | None for MV |
| | BVD: Integer-pel | BVD: Quarter-pel | None for MV | BVD: Integer-pel |
| | MVD: Quarter-pel | MVD: Quarter-pel | BVD: Integer-pel | MVD: Quarter-pel |
| | | | MVD: Quarter-pel | |
| 2^{nd} Value | BV = (P + BVD) | BV = (P + BVD) | BV = (P + BVD) | BV = (P + BVD) |
| (e.g., 1) | MV = (P + MVD) | MV = (P + MVD) | MV = (P + MVD) | MV = (P + MVD) |
| | Storage: BV = Int, MV = Q | Storage: BV = Int, MV = Int | Storage: BV = Int, MV = Int | Storage: BV = Int, MV = Int |
| | Shift for MC: <<2 for BV, | Shift for MC: <<2 for BV, | Shift for MC: <<2 for BV, | Shift for MC: <<2 for BV, |
| | <<2 for MV | <<2 for MV | <<2 for MV | <<2 for MV |
| | BVD: Integer-pel | BVD: Integer-pel | BVD: Integer-pel | BVD: Integer-pel |
| | MVD: Integer-pel | MVD: Integer-pel | MVD: Integer-pel | MVD: Integer-pel |

In another example, both the Intra BC MV and Inter MV may be stored having fractional-pixel resolution. However, the derivation process for Intra BC MV and Inter MV may be dependent on use_integer_mv_flag.

When use_integer_mv_flag=1,
a. Intra BC MVD and Inter MVD may be coded with integer-pixel resolution.
b. Both the stored Intra BC MV and Inter MV may be derived as MV=(MVP>>m+MVD)<<m.

When use_integer_mv_flag=0,
a. Intra BC MVD may be coded with integer-pixel resolution and Inter MVD may be coded with fractional-pixel resolution.
b. The stored Inter MV may be derived as MV=MVP+MVD, and the stored Intra BC MV may be derived as (MVP>>m+MVD)<<m.

Where MVP is the corresponding MV predictor. Other conversion mechanism or rounding might be applicable. For merge, the MVD may be zero and MVP may be the MV from the corresponding merge candidate. m may be dependent on the fractional-pixel resolution (e.g., m=2 for quarter-pixel resolution).

In another example, both the Intra BC MV and Inter MV may be stored having fractional-pixel resolution (e.g., quarter-pixel resolution). However, the derivation process for stored Intra BC MV and Inter MV may be dependent on

use_integer_mv_flag.

When use_integer_mv_flag=1,
a. Intra BC MVD and Inter MVD may be coded with integer-pixel resolution.
b. Both the stored Intra BC MV and Inter MV may be derived as MV=(MVP>>m+MVD)<<m.

When use_integer_mv_flag=0,
a. Intra BC MVD and Inter MVD may be coded with fractional-pixel resolution.
b. Both the stored Intra BC MV and Inter MV may be derived as MV=MVP+MVD.

Where MVP is the corresponding MV predictor. Other conversion mechanism or rounding might be applicable. For merge, the MVD may be zero and MVP may be the MV from the corresponding merge candidate. m may be dependent on the fractional-pixel resolution (e.g., m=2 for quarter-pixel resolution).

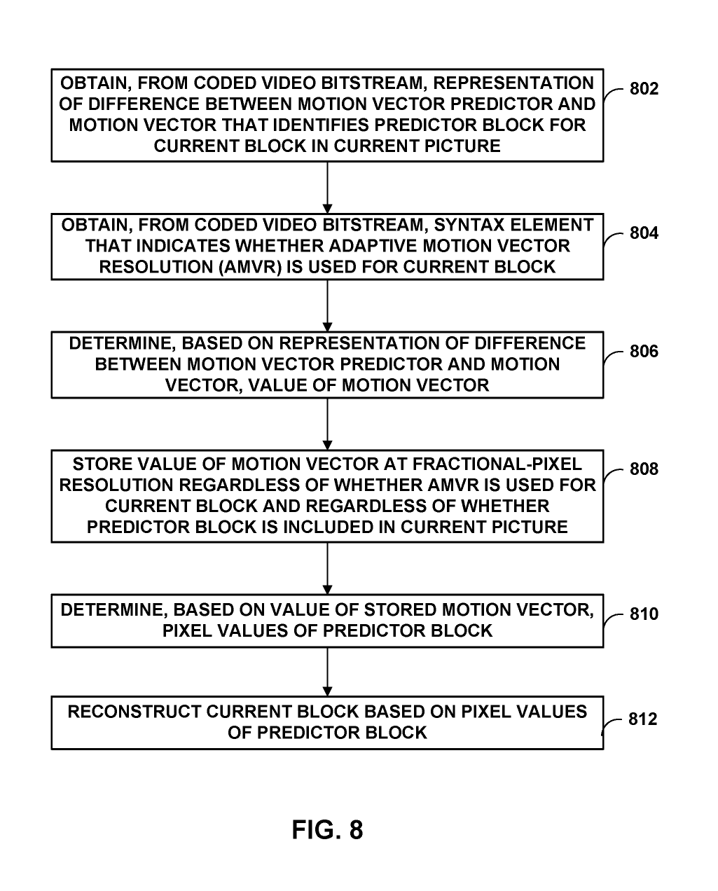

Note that in this case, interpolation filter might be needed for Intra BC, since the Intra BC/Inter MV may point to fractional-pixel position. As such, in some examples, the techniques discussed above (e.g., shrinking the search region as shown in FIGS. 8-10) may be used for Intra BC.

In another example, the resolution of stored Intra BC MV and Inter MV may be dependent on use_integer_mv_flag.

When use_integer_mv_flag=1,
a. Both the Intra BC MVD and Inter MVD may be coded with integer-pixel resolution.
b. Both the Intra BC MV and Inter MV may be stored having integer-pixel resolution.
c. Both stored Intra BC MV and Inter MV may be derived as MV=MVP+MVD.

When use_integer_mv_flag=0,
a. Both the Intra BC MVD and Inter MVD are coded with fractional-pixel resolution.
b. Both the Intra BC MV and Inter MV may be stored having fractional-pixel resolution.
c. Both stored Intra BC MV and Inter MV are derived as MV=MVP+MVD.

Note that in this case, interpolation filter might be needed for Intra BC, since the Intra BC MV may point to fractional-pixel position. As such, in some examples, the techniques discussed above (e.g., shrinking the search region as shown in FIGS. 8-10) may be used for Intra BC.

When Inter/Intra BC MV is stored with integer-pixel resolution, the following operations (one or both) may be applied.
a. The MV may be left shifted by m first to fractional-pixel resolution (m=2 for quarter-pixel resolution as in HEVC version 1) before being input to the motion compensation module. In this way, a conventional motion compensation module can be used transparently without any change.
b. The MV may be left shifted by m first to fractional-pixel resolution (m=2 for quarter-pixel resolution as in HEVC version 1) before being input to the deblocking module. In this way, a conventional deblocking module can be used transparently without any change

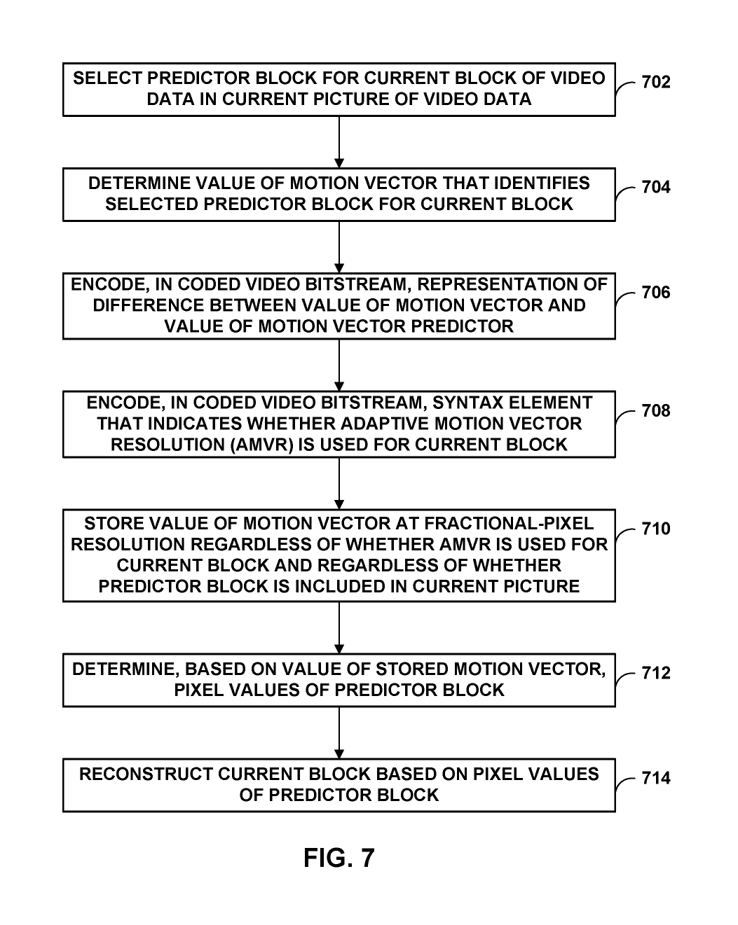

FIG. 7 is a flowchart illustrating an example process for encoding a block of video data, in accordance with one or more techniques of this disclosure. The techniques of FIG. 7 may be performed by a video encoder, such as video encoder 20 illustrated in FIG. 1 and FIG. 3. For purposes of illustration, the techniques of FIG. 7 are described within the context of video encoder 20 of FIG. 1 and FIG. 3, although video encoders having configurations different than that of video encoder 20 may perform the techniques of FIG. 7.

In accordance with one or more techniques of this disclosure, one or more processors of video encoder 20 may select a predictor block for a current block of video data in a current picture of video data (702). As one example, motion estimation unit 44 of video encoder 20 may select a predictor block for the current block from a search region. As discussed above, motion estimation unit 44 may identify several candidate predictor blocks from within the determined search region and select the candidate predictor block that closely matches the current block, in terms of pixel difference, which may be determined by sum of absolute difference (SAD), sum of square difference (SSD), or other difference metrics.

One or more processors of video encoder 20 may determine a value of a motion vector that identifies the selected predictor block for the current block (704). For instance, in the example of FIG. 5, motion estimation unit 44 may determine the value of vertical component 110 and the value of horizontal component 112 of vector 106 that represents a displacement between current block 102 and the selected predictor block 104.

One or more processors of video encoder 20 may encode, in a coded video bitstream, a representation of a difference between a motion vector predictor and the value of the motion vector (706). For instance, motion estimation unit 44 may cause entropy encoding unit 56 to encode one or more syntax elements that represent the value of a motion vector difference (MVD)) between the determined motion vector and a motion vector predictor for the determined motion vector.

One or more processors of video encoder 20 may encode, in a coded video bitstream, a syntax element that indicates whether adaptive motion vector resolution (AMVR) is used for the current block (708). For instance, motion estimation unit 44 may cause entropy encoding unit 56 to encode a use_integer_mv_flag in a slice header of a slice that includes the current block with a value that indicates whether AMVR is used for the current block.

One or more processors of video encoder 20 may store the value of the motion vector at fractional-pixel resolution (e.g., quarter-pixel resolution) regardless of whether adaptive motion vector resolution is used for the current block of video data and regardless of whether the predictor block is included in the current picture (710). As discussed above, by always storing the value of the motion vector at fractional-pixel resolution video encoder 20 may reduce the complexity of using predictor blocks in the current picture.

One or more processors of video encoder 20 may determine, based on the value of the stored motion vector, pixel values of the predictor block (712), and reconstruct the current block based on the pixel values of the predictor block (714). For instance, video encoder 20 may add the pixel values of the predictor block to residual values to reconstruct the pixel values of the current block.

FIG. 8 is a flowchart illustrating an example process for decoding a block of video data, in accordance with one or more techniques of this disclosure. The techniques of FIG. 8 may be performed by a video decoder, such as video decoder 30 illustrated in FIG. 1 and FIG. 4. For purposes of illustration, the techniques of FIG. 8 are described within the context of video decoder 30 of FIG. 1 and FIG. 4, although video decoders having configurations different than that of video decoder 30 may perform the techniques of FIG. 8.

In accordance with one or more techniques of this disclosure, one or more processors of video decoder 30 may obtain, from a coded video bitstream, a representation of a difference between a motion vector predictor and a motion vector that identifies a predictor block for a current block of video data in a current picture of video data (802). For instance, motion compensation unit 72 of video decoder 30 may receive, from entropy decoding unit 70, one or more syntax elements that represent the value of a motion vector difference (MVD)) between the determined motion vector and a motion vector predictor for the determined motion vector.

One or more processors of video decoder 30 may obtain, from the coded video bitstream, a syntax element that indicates whether adaptive motion vector resolution (AMVR) is used for the current block (804). For instance, motion compensation unit 72 may receive, from entropy decoding unit 70, a use_integer_mv_flag that includes the current block with a value that indicates whether AMVR is used for the current block.

One or more processors of video decoder 30 may determine, based on the representation of the difference between the motion vector predictor and the motion vector that identifies the predictor block, a value of the motion vector (806). As one example, where the syntax element indicates that AMVR is used for the current block of video data or the predictor block is included in the current picture, motion compensation unit 72 may determine the value of the motion vector by at least right-shifting the motion vector predictor by two, and left-shifting the sum of the right-shifted motion vector predictor and the representation of the difference between the motion vector predictor and the motion vector that identifies the predictor block by two. As another example, where the syntax element indicates that AMVR is not used for the current block of video data and the predictor block is not included in the current picture, motion compensation unit 72 may determine the value of the motion vector by at least adding the motion vector predictor to the representation of the difference between the motion vector predictor and the motion vector that identifies the predictor block.

One or more processors of video decoder 30 may store the value of the motion vector at fractional-pixel resolution (e.g., quarter-pixel resolution) regardless of whether adaptive motion vector resolution is used for the current block of video data and regardless of whether the predictor block is included in the current picture (808). As discussed above, by always storing the value of the motion vector at fractional-pixel resolution video decoder 30 may reduce the complexity of using predictor blocks in the current picture.

One or more processors of video decoder 30 may determine, based on the value of the stored motion vector, pixel values of the predictor block (810), and reconstruct the current block based on the pixel values of the predictor block (812). For instance, summer 80 of video decoder 30 may add the pixel values of the predictor block to residual values to reconstruct the pixel values of the current block.

The following numbered examples may illustrate one or more aspects of the disclosure:

### Example 1

A method of decoding video data, the method comprising: obtaining, from a coded video bitstream, a representation of a difference between a motion vector predictor and a motion vector that identifies a predictor block for a current block of video data in a current picture; obtaining, from the coded video bitstream, a syntax element that indicates whether adaptive motion vector resolution is used for the current block of video data; determining, based on the representation of the difference between the motion vector predictor and the motion vector that identifies the predictor block, a value of the motion vector; storing the value of the motion vector at fractional-pixel resolution regardless of whether adaptive motion vector resolution is used for the current block of video data and regardless of whether the predictor block is included in the current picture; determining, based on the value of the stored motion vector, pixel values of the predictor block; and reconstructing the current block based on the pixel values of the predictor block.

### Example 2

The method of example 1, wherein determining the pixel values of the predictor block based on the value of the motion vector comprises: identifying, without scaling the value of the stored motion vector and regardless of whether the predictor block is included in the current picture, the predictor block.

### Example 3

The method of any combination of examples 1-2, wherein, where the syntax element indicates that adaptive motion vector resolution is used for the current block of video data or the predictor block is included in the current picture, and wherein determining the value of the motion vector comprises: right-shifting the motion vector predictor by N; and left-shifting the sum of the right-shifted motion vector predictor and the representation of the difference between the motion vector predictor and the motion vector that identifies the predictor block by N.

### Example 4

The method of any combination of examples 1-3, wherein N is two.

### Example 5

The method of any combination of examples 1-4, wherein, where the syntax element indicates that adaptive motion vector resolution is not used for the current block of video data and the predictor block is not included in the current picture, and wherein determining the value of the motion vector comprises: adding the motion vector predictor to the representation of the difference between the motion vector predictor and the motion vector that identifies the predictor block.

### Example 6

The method of any combination of examples 1-5, wherein storing the value of the motion vector at fractional-pixel resolution comprises storing the value of the motion vector at quarter-pixel resolution regardless of whether adaptive motion vector resolution is used for the current block of video data and regardless of whether the predictor block is included in the current picture.

### Example 7

A device for decoding video data, the device comprising a memory configured to store a portion of the video data; and one or more processors configured to perform the method of any combination of examples 1-6.

### Example 8

A device for decoding video data, the device comprising means for performing the method of any combination of examples 1-6.

### Example 9

A computer-readable storage medium storing instructions that, when executed, cause one or more processors of a video decoder to perform the method of any combination of examples 1-6.

### Example 10

A method of encoding video data, the method comprising: selecting a predictor block for a current block of video data in a current picture of video data; determining a value of a motion vector that identifies the selected predictor block for the current block; encoding, in a coded video bitstream, a representation of a difference between a motion vector predictor and the value of the motion vector; encoding, in the coded video bitstream, a syntax element that indicates whether adaptive motion vector resolution is used for the current block of video data; storing the value of the motion vector at fractional-pixel resolution regardless of whether adaptive motion vector resolution is used for the current block of video data and regardless of whether the predictor block is included in the current picture; determining, based on the value of the stored motion vector, pixel values of the predictor block; and reconstructing the current block based on the pixel values of the predictor block.

### Example 11

The method of example 10, wherein determining the pixel values of the predictor block based on the value of the motion vector comprises: identifying, without scaling the value of the stored motion vector and regardless of whether the predictor block is included in the current picture, the predictor block.

### Example 12

The method of any combination of examples 10-11, wherein, where adaptive motion vector resolution is used for the current block of video data or the predictor block is included in the current picture, and wherein determining the value of the motion vector comprises: right-shifting the motion vector predictor by N; and left-shifting the sum of the right-shifted motion vector predictor and the representation of the difference between the motion vector predictor and the motion vector that identifies the predictor block by N.

### Example 13

The method of any combination of examples 10-12, wherein N is two.

### Example 14

The method of any combination of examples 10-13, wherein, where adaptive motion vector resolution is not used for the current block of video data and the predictor block is not included in the current picture, and wherein determining the value of the motion vector comprises: adding the motion vector predictor to the representation of the difference between the motion vector predictor and the motion vector that identifies the predictor block.

### Example 15

The method of any combination of examples 10-14, wherein storing the value of the motion vector at fractional-pixel resolution comprises storing the value of the motion vector at quarter-pixel resolution regardless of whether adaptive motion vector resolution is used for the current block of video data and regardless of whether the predictor block is included in the current picture.

### Example 16

A device for encoding video data, the device comprising a memory configured to store a portion of the video data; and one or more processors configured to perform the method of any combination of examples 10-15.

### Example 17

A device for encoding video data, the device comprising means for performing the method of any combination of examples 10-15.

### Example 18

A computer-readable storage medium storing instructions that, when executed, cause one or more processors of a video encoder to perform the method of any combination of examples 10-15.

A video coder, as described in this disclosure, may refer to a video encoder or a video decoder. Similarly, a video coding unit may refer to a video encoder or a video decoder. Likewise, video coding may refer to video encoding or video decoding, as applicable.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol.

In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
obtaining, from a coded video bitstream, a representation of a difference between a motion vector predictor and a motion vector that identifies a predictor block for a current block of video data in a current picture;
obtaining, from the coded video bitstream, a syntax element that indicates whether adaptive motion vector resolution is used for the current block of video data;
determining, based on the representation of the difference between the motion vector predictor and the motion vector that identifies the predictor block, a value of the motion vector;
storing the value of the motion vector at fractional-pixel resolution regardless of whether adaptive motion vector resolution is used for the current block of video data and regardless of whether the predictor block is included in the current picture;
determining, based on the value of the stored motion vector, pixel values of the predictor block; and
reconstructing the current block based on the pixel values of the predictor block.

2. The method of claim 1, wherein determining the pixel values of the predictor block based on the value of the motion vector comprises:
identifying, without scaling the value of the stored motion vector and regardless of whether the predictor block is included in the current picture, the predictor block.

3. The method of claim 2, wherein, where the syntax element indicates that adaptive motion vector resolution is used for the current block of video data or the predictor block is included in the current picture, and wherein determining the value of the motion vector comprises:
right-shifting the motion vector predictor by N; and
left-shifting the sum of the right-shifted motion vector predictor and the representation of the difference between the motion vector predictor and the motion vector that identifies the predictor block by N.

4. The method of claim 3, wherein N is two.

5. The method of claim 3, wherein, where the syntax element indicates that adaptive motion vector resolution is not used for the current block of video data and the predictor block is not included in the current picture, and wherein determining the value of the motion vector comprises:
adding the motion vector predictor to the representation of the difference between the motion vector predictor and the motion vector that identifies the predictor block.

6. The method of claim 1, wherein storing the value of the motion vector at fractional-pixel resolution comprises storing the value of the motion vector at quarter-pixel resolution regardless of whether adaptive motion vector resolution is used for the current block of video data and regardless of whether the predictor block is included in the current picture.

7. A method of encoding video data, the method comprising:
selecting a predictor block for a current block of video data in a current picture of video data;
determining a value of a motion vector that identifies the selected predictor block for the current block;
encoding, in a coded video bitstream, a representation of a difference between a motion vector predictor and the value of the motion vector;
encoding, in the coded video bitstream, a syntax element that indicates whether adaptive motion vector resolution is used for the current block of video data;
storing the value of the motion vector at fractional-pixel resolution regardless of whether adaptive motion vector resolution is used for the current block of video data and regardless of whether the predictor block is included in the current picture;
determining, based on the value of the stored motion vector, pixel values of the predictor block; and
reconstructing the current block based on the pixel values of the predictor block.

8. The method of claim 7, wherein determining the pixel values of the predictor block based on the value of the motion vector comprises:
identifying, without scaling the value of the stored motion vector and regardless of whether the predictor block is included in the current picture, the predictor block.

9. The method of claim 8, wherein, where adaptive motion vector resolution is used for the current block of video data or the predictor block is included in the current picture, and wherein determining the value of the motion vector comprises:
right-shifting the motion vector predictor by N; and
left-shifting the sum of the right-shifted motion vector predictor and the representation of the difference between the motion vector predictor and the motion vector that identifies the predictor block by N.

10. The method of claim 9, wherein N is two.

11. The method of claim 9, wherein, where adaptive motion vector resolution is not used for the current block of video data and the predictor block is not included in the current picture, and wherein determining the value of the motion vector comprises:
adding the motion vector predictor to the representation of the difference between the motion vector predictor and the motion vector that identifies the predictor block.

12. The method of claim 7, wherein storing the value of the motion vector at fractional-pixel resolution comprises storing the value of the motion vector at quarter-pixel resolution regardless of whether adaptive motion vector resolution is used for the current block of video data and regardless of whether the predictor block is included in the current picture.

13. A device for decoding video data, the device comprising:
a memory configured to store a portion of the video data; and
one or more processors configured to:
obtain, from a coded video bitstream, a representation of a difference between a motion vector predictor and a motion vector that identifies a predictor block for a current block of video data in a current picture;
obtain, from the coded video bitstream, a syntax element that indicates whether adaptive motion vector resolution is used for the current block of video data;
determine, based on the representation of the difference between the motion vector predictor and the motion vector that identifies the predictor block, a value of the motion vector;
store the value of the motion vector at fractional-pixel resolution regardless of whether adaptive motion vector resolution is used for the current block of video data and regardless of whether the predictor block is included in the current picture;
determine, based on the value of the stored motion vector, pixel values of the predictor block; and
reconstruct the current block based on the pixel values of the predictor block.

14. The device of claim 13, wherein, to determine the pixel values of the predictor block based on the value of the motion vector, the one or more processors are configured to:
identify, without scaling the value of the stored motion vector and regardless of whether the predictor block is included in the current picture, the predictor block.

15. The device of claim 14, wherein, where the syntax element indicates that adaptive motion vector resolution is used for the current block of video data or the predictor block is included in the current picture, and wherein, to determine the value of the motion vector, the one or more processors are configured to:
right-shift the motion vector predictor by N; and
left-shift the sum of the right-shifted motion vector predictor and the representation of the difference between the motion vector predictor and the motion vector that identifies the predictor block by N.

16. The device of claim 15, wherein N is two.

17. The device of claim 15, wherein, where the syntax element indicates that adaptive motion vector resolution is not used for the current block of video data and the predictor block is not included in the current picture, and wherein, to determine the value of the motion vector, the one or more processors are configured to:
add the motion vector predictor to the representation of the difference between the motion vector predictor and the motion vector that identifies the predictor block.

18. The device of claim 13, wherein, to store the value of the motion vector at fractional-pixel resolution, the one or more processors are configured to store the value of the motion vector at quarter-pixel resolution regardless of whether adaptive motion vector resolution is used for the current block of video data and regardless of whether the predictor block is included in the current picture.

19. An apparatus for decoding video data, the apparatus comprising:
means for obtaining, from a coded video bitstream, a representation of a difference between a motion vector predictor and a motion vector that identifies a predictor block for a current block of video data in a current picture;
means for obtaining, from the coded video bitstream, a syntax element that indicates whether adaptive motion vector resolution is used for the current block of video data;
means for determining, based on the representation of the difference between the motion vector predictor and the motion vector that identifies the predictor block, a value of the motion vector;
means for storing the value of the motion vector at fractional-pixel resolution regardless of whether adaptive motion vector resolution is used for the current block of video data and regardless of whether the predictor block is included in the current picture;
means for determining, based on the value of the stored motion vector, pixel values of the predictor block; and
means for reconstructing the current block based on the pixel values of the predictor block.

20. A computer-readable storage medium storing instructions that, when executed, cause one or more processors of a video decoding device to:
obtain, from a coded video bitstream, a representation of a difference between a motion vector predictor and a motion vector that identifies a predictor block for a current block of video data in a current picture;
obtain, from the coded video bitstream, a syntax element that indicates whether adaptive motion vector resolution is used for the current block of video data;
determine, based on the representation of the difference between the motion vector predictor and the motion vector that identifies the predictor block, a value of the motion vector;
store the value of the motion vector at fractional-pixel resolution regardless of whether adaptive motion vector resolution is used for the current block of video data and regardless of whether the predictor block is included in the current picture;
determine, based on the value of the stored motion vector, pixel values of the predictor block; and
reconstruct the current block based on the pixel values of the predictor block.

21. A device for encoding video data, the device comprising:
a memory configured to store a portion of the video data; and
one or more processors configured to:
select a predictor block for a current block of video data in a current picture of video data;
determine a value of a motion vector that identifies the selected predictor block for the current block;
encode, in a coded video bitstream, a representation of a difference between a motion vector predictor and the value of the motion vector;
encode, in the coded video bitstream, a syntax element that indicates whether adaptive motion vector resolution is used for the current block of video data;
store the value of the motion vector at fractional-pixel resolution regardless of whether adaptive motion vector resolution is used for the current block of video data and regardless of whether the predictor block is included in the current picture;
determine, based on the value of the stored motion vector, pixel values of the predictor block; and
reconstruct the current block based on the pixel values of the predictor block.

22. The device of claim 21, wherein, to determine the pixel values of the predictor block based on the value of the motion vector, the one or more processors are configured to:
identify, without scaling the value of the stored motion vector and regardless of whether the predictor block is included in the current picture, the predictor block.

23. The device of claim 22, wherein, where adaptive motion vector resolution is used for the current block of video data or the predictor block is included in the current picture, and wherein, to determine the value of the motion vector, the one or more processors are configured to:
right-shift the motion vector predictor by N; and
left-shift the sum of the right-shifted motion vector predictor and the representation of the difference between the motion vector predictor and the motion vector that identifies the predictor block by N.

24. The device of claim 23, wherein N is two.

25. The device of claim 23, wherein, where adaptive motion vector resolution is not used for the current block of video data and the predictor block is not included in the current picture, and wherein, to determine the value of the motion vector, the one or more processors are configured to:
add the motion vector predictor to the representation of the difference between the motion vector predictor and the motion vector that identifies the predictor block.

26. The device of claim 21, wherein, to store the value of the motion vector at fractional-pixel resolution, the one or more processors are configured to store the value of the motion vector at quarter-pixel resolution regardless of whether adaptive motion vector resolution is used for the current block of video data and regardless of whether the predictor block is included in the current picture.

27. An apparatus for encoding video data, the apparatus comprising:
means for selecting a predictor block for a current block of video data in a current picture of video data;
means for determining a value of a motion vector that identifies the selected predictor block for the current block;
means for encoding, in a coded video bitstream, a representation of a difference between a motion vector predictor and the value of the motion vector;
means for encoding, in the coded video bitstream, a syntax element that indicates whether adaptive motion vector resolution is used for the current block of video data;
means for storing the value of the motion vector at fractional-pixel resolution regardless of whether adaptive motion vector resolution is used for the current block of video data and regardless of whether the predictor block is included in the current picture;
means for determining, based on the value of the stored motion vector, pixel values of the predictor block; and
means for reconstructing the current block based on the pixel values of the predictor block.

28. A computer-readable storage medium storing instructions that, when executed, cause one or more processors of a video encoding device to:
select a predictor block for a current block of video data in a current picture of video data;
determine a value of a motion vector that identifies the selected predictor block for the current block;
encode, in a coded video bitstream, a representation of a difference between a motion vector predictor and the value of the motion vector;
encode, in the coded video bitstream, a syntax element that indicates whether adaptive motion vector resolution is used for the current block of video data;
store the value of the motion vector at fractional-pixel resolution regardless of whether adaptive motion vector resolution is used for the current block of video data and regardless of whether the predictor block is included in the current picture;
determine, based on the value of the stored motion vector, pixel values of the predictor block; and
reconstruct the current block based on the pixel values of the predictor block.
